(19) United States
(12) Patent Application Publication
(10) Pub. No.: US 2022/0377424 A1
(43) Pub. Date: Nov. 24, 2022

(54) DYNAMIC DIGITAL CONTENT DELIVERY USING ARTIFICIAL INTELLIGENCE (AI) TECHNIQUES

(71) Applicant: Meta Platforms, Inc., Menlo Park, CA (US)

(72) Inventors: Zi Yu Daniel DENG, San Ramon, CA (US); Brian FOX, Chicago, IL (US); Keenan Christopher PRIDMORE, Wilmette, IL (US); Aditi RAJAGOPAL, Singapore (SG); Dana Michelle JEFFERSON, Astoria, NY (US); Daniel BOTTAS, Sao Paulo (BR); Cynthia AGUSTINA, Singapore (SG); Oleg PASHKOVSKY, Los Angeles, CA (US)

(73) Assignee: Meta Platforms, Inc., Menlo Park, CA (US)

(21) Appl. No.: 17/738,858

(22) Filed: May 6, 2022

Related U.S. Application Data
(60) Provisional application No. 63/190,005, filed on May 18, 2021.
(60) Provisional application No. 63/236,736, filed on Aug. 25, 2021.
(60) Provisional application No. 63/235,279, filed on Aug. 20, 2021.

(51) Int. Cl. H04N 21/466; H04N 21/44; H04N 21/81

(52) U.S. Cl. CPC H04N 21/4662; H04N 21/44016; H04N 21/81

(57) ABSTRACT

According to examples, a system for providing dynamic digital content may include a processor and a memory storing instructions. The processor, when executing the instructions, may cause the system to receive a plurality of data feeds. The processor may further analyze the data feeds to identify values for parameterized variables. A plurality of deep learning (DL) models can be trained to obtain product attribute data from the data feeds. The processor may then identify rules or triggers based on the values of the parameterized variables. The rules and/or triggers cause the processor to dynamically generate or select digital content and transmit the digital content to user communication devices of selected audience.

### PRIORITY

This patent application claims priority to U.S. Provisional Patent Application No. 63/190,005, entitled “Dynamic Digital Content Delivery using Artificial Intelligence (AI) Techniques with Parameterized Variables,” filed on May 18, 2021, U.S. Provisional Patent Application No. 63/236,736, entitled “Dynamic Digital Content Delivery and Management Using Exclusions,” filed on Aug. 25, 2021, and U.S. Provisional Patent Application No. 63/235,279, entitled “Real-Time Generation and Delivery of Template-based Content Using a Rendering Ecosystem,” filed on Aug. 20, 2021, all of which are hereby incorporated by reference herein in their entireties.

### TECHNICAL FIELD

This patent application relates generally to digital content customization using AI techniques for parameterized variables that take values from data feeds of different data sources and mechanisms to deliver customized digital content over communications devices. This patent application relates generally to presenting digital content using artificial intelligence (AI) based techniques, and more specifically, to systems and methods for dynamic digital content delivery and management using exclusion services. This patent application relates generally to generation and delivery of content, and more specifically, to systems and methods for enabling users to plurally generate uniform content in real-time based on a specified template using a rendering ecosystem employing augmented reality (AR) techniques.

### BACKGROUND

Digital content is any information that exists in the form of digital data. Also known as digital media, digital content is stored on digital or analog storage devices in specific formats. Forms of digital content include information that is digitally broadcast, streamed, or contained in computer files. With the current advances in technology, the prevalence and proliferation of digital content creation and delivery have increased greatly in recent years. However, the digital content that is currently delivered is rather static so that the content to be delivered and the users who receive the digital content may be predetermined. Any changes or updates that may occur in the real world can only be incorporated by producing the digital content afresh or re-defining content transmission parameters which is a time-consuming process and hence the updates may not be conveyed to the users in real-time.

With the current advances in technology, the prevalence and proliferation of digital content creation and delivery have increased greatly in recent years. Some digital content delivery and management systems may collect and manage user preferences to enable customized digital content delivery to the users. However, conventional digital content delivery systems may not have reliable mechanisms to avoid over-targeting users. Furthermore, such systems may lack the capability to determine the effectiveness of the digital content delivered to the users in the absence of explicit user feedback. As a result, irrelevant or obsolete digital content may be delivered to users thereby causing content distribution inefficiencies and lowering quality of user experience.

With recent advances in technology, prevalence and proliferation of content creation and delivery has increased greatly in recent years. Content creators, such as vendors looking to advertise goods or services, are continuously looking for ways to deliver more appealing content.

For some content creators, digital advertising may provide an appealing option due to its efficient and versatile nature. Digital advertising may be efficient in that may enable a content creator to target particular audiences that may be predisposed. Digital advertising may be versatile in that it may be deployed over a variety of content platforms.

However, digital advertising may also come with its own drawbacks. For example, creation of digital advertising content may sometimes require significant amounts of “post-processing” (e.g., editing, addition of visual or audio effects, formatting, etc.). However, in many instances, content creators may not have skills required to generate professional-quality content. Moreover, enlisting help from those with the required skills may be costly and time-consuming as well.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures may be employed without departing from the principles described herein.

FIG. 1A illustrates a block diagram of a computer system used for customization and transmission of digital content, according to an example.

FIG. 1B illustrates a block diagram of a memory included in the computer system used for customization and transmission of digital content, according to an example.

FIG. 2 shows a flowchart that details a method of providing dynamic digital content according to an example.

FIG. 3 shows a flowchart that details a method of providing dynamic digital content in the fashion segment according to an example.

FIG. 4 shows a flowchart that details a method of trend detection and implementation for stores according to some examples.

FIG. 5 shows a flowchart that details a method of providing product recommendations according to an example.

FIG. 6 illustrates a block diagram of a system for providing recommendations, according to an example.

FIG. 7A illustrates a block diagram of a computer system used for delivering digital content based on user feedback, according to an example.

FIG. 7B illustrates a block diagram of a memory included in the computer system used for presenting digital content per user feedback according to an example.

FIG. 8 shows a flowchart that details a method of determining similarity between digital content items according to an example.

FIG. 9 shows a flowchart of a method to build user profiles according to an example.

FIG. 10 shows a data flow diagram of a process to implement user incentives within content-providing networks according to an example.

FIGS. 11A-11B illustrates a block diagram of a system environment, including a system, that may be implemented to provide real-time generation of content according to a specified template using a real-time rendering ecosystem employing augmented reality (AR) techniques which may enable users to plurally and uniformly generate content, according to an example.

FIG. 11C illustrates a user interface providing access to a portal for a creating user to specify aspects of a template, according to an example.

FIG. 11D illustrates a user interface for selection of a design theme for a template, according to an example.

FIG. 11E illustrates a user interface for selection of a template type, according to an example.

FIG. 11F illustrates a user interface for selection of a logo, according to an example.

FIG. 11G illustrates a user interface for selection of a font for a template, according to an example.

FIG. 11H illustrates a first user interface for selection of one or more colors for a template, according to an example.

FIG. 11I illustrates a second user interface for selection of one or more colors for a template, according to an example.

FIG. 11J illustrates a user interface for selection of one or more modules for a template, according to an example.

FIG. 11K illustrates a user interface for selection of a location for a template, according to an example.

FIG. 11L illustrates a user interface for providing contact information, according to an example.

FIG. 11M illustrates a user interface for providing information related to a special offer, according to an example.

FIG. 11N illustrates a user interface for enabling a user to input a delivery email address, according to an example.

FIG. 11O illustrates a user interface for a completion page for a completed template, according to an example.

FIG. 11P illustrates a plurality of user interfaces for receiving publication information from a publishing user, according to examples.

FIG. 11Q illustrates a user interface of a generated content item generated, according to an example.

FIG. 12 illustrates a block diagram of a computer system to generate and deliver of content via remote rendering and data streaming, according to an example.

FIG. 13 illustrates a method for generating and delivering content to a user via remote rendering and real-time streaming, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Systems and methods for online delivery of dynamic digital content wherein the parameters associated with the creation and transmission of the digital content may be varied in real-time based on updates received in data feeds are disclosed. A data feed is a mechanism to receive updated data from a data source. It is generally used in real-time applications in point-to-point settings and World Wide Web (e.g., web feed). As used herein, “digital content”, “digital content item” and “content item” may refer to any digital data (e.g., a data file). Examples of digital content items include, but are not limited to, digital images, digital video files, digital audio files, and/or streaming content. It should also be appreciated that the systems and methods described herein may be particularly suited for digital content, such as video, animation, and/or other interactive media, some or all of which may be associated with any number of online actions, emergency notifications, advertisements, and/or financial transactions. These and other benefits will be apparent in the description provided herein.

The systems and methods described herein may provide customized and context-aware generation and delivery of digital content (e.g., a notification, an advertisement, etc.). The party providing the notifications may predefine specific objectives or target criteria that are to be met to transmit specific digital content to a selected section of users. Furthermore, the content of the notifications may also be dynamically determined on the fly based on the existing circumstances. More particularly, a digital content generation and the delivery system receives data feeds from a plurality of data sources. The information to be included in the digital content and values of the parameterized variables associated with the transmission of the digital content may be determined based on the data feeds. The parameterized variable values may be further processed to determine if they satisfy one or more rules that trigger actions associated with delivering specific digital content to predefined users or to a user group that is identified based on one or more of the parametrized variable values derived in real-time from the data feeds.

Different examples are discussed herein including emergency response systems, situational advertisements, etc., wherein digital content that is customized based on received data feeds is transmitted to selected users. An example discussed herein for customized, context-aware content generation is the incorporation of trends into ads and customer visits to physical store locations.

This connects the two often disparate worlds, making trends an integral part of ads and shops via a real-time customizable, machine learning-driven automation.

Trends are living and breathing aggregated functions of popularity diversified across geo-locations, demographic segments, time periods, weather, season, holidays, mood, ongoing events, situations, personal happenings, etc. Trends in eCommerce have many factors in play from many different dimensions such as colors, styles, shapes, features, products, etc., and maybe forever changing. They are volatile and oftentimes illogical, regional, whimsical, which makes trends hard to track, predict and practically deploy for just-in-time platforms on a large scale.

Shops generally lack an automated and efficient way to customize product offerings to different customer segments based on trends. Shops including small and medium businesses especially need an effective way to refresh and customize ad creatives to best connect with trending dynamics. The disconnect between shops and ads as services arises as they are provided by different platforms which may not necessarily connect. Lack of large-scale, real-time, customizable trending automation in shops and ads causes a long lag, ineffective, mismatch, and disliked ads and products resulting in lost revenue and bad consumer experiences. Manual efforts to adapt product catalog and ad creative iterations are both costly and less productive than ideal. Purchase funnel data, from ads impression, clicks, conversions and purchases, may form the connecting bridge between ads and shops.

While example trends are discussed herein with respect to fashion goods, it may be appreciated that the term ‘trends’ is used here as a general term, and may not be limited to fashion trends only, but may also apply to user preferences in tastes, cuisines, temperatures, decorations, lifestyles, seatings, spending habits, etc. Trends are different than typical traits (e.g., implicit or explicit user preferences). User preferences may either remain the same or may change, but generally even those changes may occur over a longer time period whereas trends may be volatile i.e., changing constantly, whimsical, subject to influences that hinge on many factors and tied specifically to a tangible product. For example, a user might like red classic style handbags but black fashion shoes. As a result, trends may be represented as vectors specific with elements including but not limited to users, products, or other elements, and deep learning (DL) statistical models may be applied for trend detection and prediction. More particularly, the deep learning (DL) statistical models may be continuously trained on trending data thereby constantly evolving and shifting to the most trendy when inferencing or predicting for a consumer checking out a product at a particular moment. Social factors may be particularly influential in social shopping scenarios aggregating trend preferences from the social circle on top of the prevailing trends. Therefore, different mechanisms are discussed to identify and capture trends and customize content to the ongoing trends.

However, current digital content delivery systems e.g., online entertainment, education, or even advertisement platforms are static in that the content providers need to define the parameters for content transmission in advance and are therefore not particularly suited to capture, analyze or propagate trend data. For example, in the advertising sector, the ad campaign parameters such as the audience, the targeting criteria, reach, frequency, etc., need to be defined in advance during campaign set up. The digital content then awaits the completion of the approval process before being delivered to the target audience. If any changes are needed, such as revising the targeting criteria, the digital content again needs to go through the same pipeline to revise the related campaigns, publish, and then await approvals to go live. While in some sections, such delay may not impact the efficiency, in situations such as emergency responses/assistance, advertising, etc., there is a requirement to quickly respond to rapidly changing situations that create fluid scenarios. Having accurate, timely data enables content providers to supply context-aware, relevant content as opposed to continuing the transmission of static content wherein the information may be obsolete.

Serving irrelevant or obsolete content in situations that demand context-aware, relevant content may hurt the content provider and negatively impact parties in the online content-providing ecosystem. For example, advertisers may run online campaigns based on outdated information such as expired trends wasting marketing spending, and being unable to adjust the campaign appropriately. Users could receive inappropriate ads during situations resulting in bad experiences and potential damage to the advertised brand, product, and/or service. Ad networks also suffer bad ad performance and lost ad spending when advertisers pause or stop otherwise running campaigns.

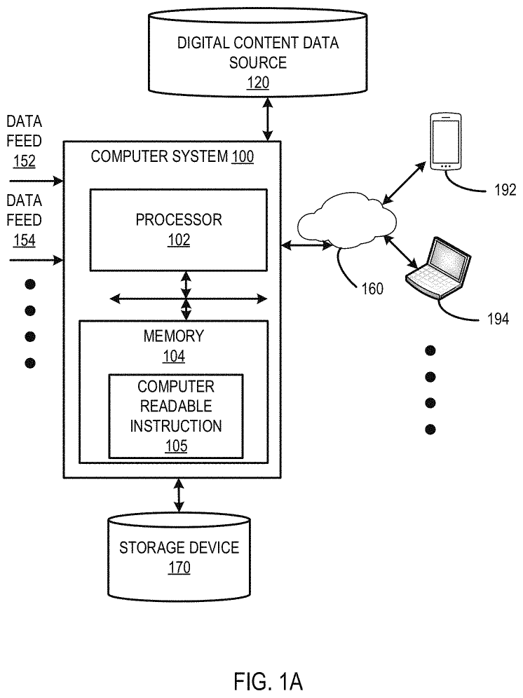

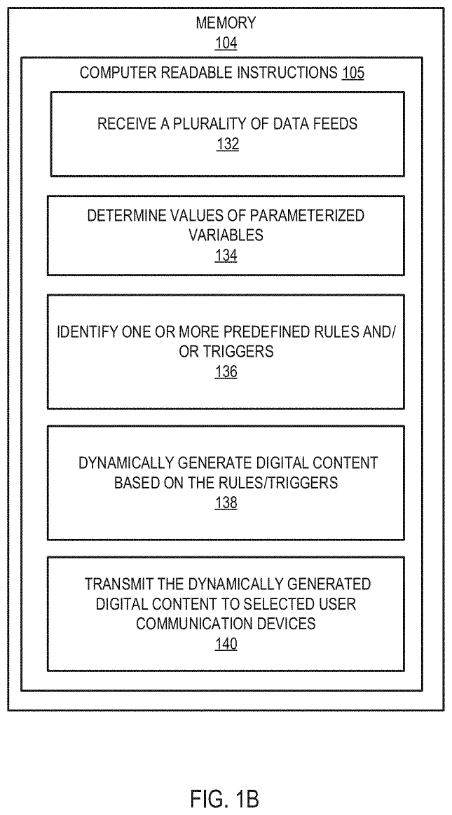

Reference is now made with respect to FIGS. 1A and 1B which illustrate a block diagram of a computer system 100 and a memory 104 included therein that is used for customization and transmission of digital content, according to an example. As shown in FIG. 1A the computer system 100 may include a processor 102 and a memory 104. FIG. 1B illustrates a block diagram of the memory 104 including computer-readable instructions 105, that when executed by the processor 102 may be configured to customize and deliver digital content over user communications devices 192, 194 . . . , etc., according to an example. The user communication devices may be electronic or computing devices configured to transmit and/or receive data (e.g., via a social media application), and in one example, the user communication device 192 may be a smartphone, and the user communication device 194 may be a laptop.

The computer system 100 may communicate with the user communication devices 192, 194 . . . , etc., via a network 160 that may be a local area network (LAN), a wide area network (WAN), the Internet, a cellular network, a cable network, a satellite network, or another network. Network 160 may further include one, or any number, of the exemplary types of networks mentioned above operating as a stand-alone network or in cooperation with each other. For example, the network 160 may utilize one or more protocols of one or more clients or servers to which they are communicatively coupled. Network 160 may facilitate the transmission of data according to a transmission protocol of any of the devices and/or systems in the network 160. Although network 160 is depicted as a single network, it should be appreciated that, in some examples, the network 160 may include a plurality of interconnected networks as well.

It should be appreciated that the systems and subsystems shown herein, as described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the servers, systems, subsystems, and/or other computing devices may be shown as single components or elements, it should be appreciated that one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the computer system 100 or the system environment including the computer system 100, the user communication devices 192, . . . etc., the dynamic digital content data source 120 and the plurality of data feeds.

The computer system 100 may further include the storage device 170. In one example, the storage device 170 may include any number of servers, hosts, systems, and/or databases that store data to be accessed by the computer system 100 or other systems (not shown) that may be communicatively coupled thereto. Also, in one example, the servers, hosts, systems, and/or databases of the storage device 170 may include one or more storage mediums storing any data, and may be utilized to store information (e.g., user information, demographic information, preference information, etc.) relating to users of a social media application facilitating the generation and transmission of dynamic digital content.

The computer system 100 may be communicatively coupled to a plurality of data feeds 152, 154, . . . , that provide updates associated with different information sources. In the example of the emergency response system tracking a storm, the plurality of data feeds 152, 154, . . . , may include a weather feed providing updates regarding the severity of the storm, a geo-location feed providing updates regarding the weather at specific locations in the trajectory of the storm, a government notification feed with instructions to residents in the vulnerable areas regarding evacuation procedures, etc., a feed from brick and mortar stores with updates regarding supplies required during weather emergencies, etc. In an example associated with digital content that is dynamically determined for a traffic jam situation, the plurality of data feeds 152, 154, . . . , may include a traffic feed with updates on the traffic situation, a geo-location feed tracking the traffic at different locations, an optional weather feed regarding weather updates at the traffic jam location, etc. In an example wherein trend data is refreshed to provide the latest trends relevant to a user's preferences, the plurality of data feeds 152, 154, . . . may pertain to sales, browsing, and other user interaction and transaction information of a store. Thus, depending on different applications, the computer system 100 may be configured to receive different data feeds. The computer system 100 is also communicatively coupled to a digital content data source 120. In another example, the digital content data source 120 may be a part of a digital content platform that supplies digital content on demand. The processor 102 in the computer system 100 accesses the computer-readable instructions 105 from the memory 104 to execute various processes that enable the creation and transmission of dynamic digital content as described herein.

In one example, the memory 104 may have stored thereon machine-readable instructions (which may also be termed computer-readable instructions) that the processor 102 may execute. The memory 104 may be an electronic, magnetic, optical, or another physical storage device that contains or stores executable instructions. The memory 104 may be, for example, Random Access Memory (RAM), an Electrically Erasable Programmable Read-Only Memory (EEPROM), a storage device, an optical disc, or the like. The memory 104, which may also be referred to as a computer-readable storage medium, may be a non-transitory machine-readable storage medium, where the term “non-transitory” does not encompass transitory propagating signals.

More particularly, the processor 102 may execute instructions 132 to receive the plurality of data feeds 152, 154, . . . . Different types of feeds including web feeds related to news, weather, RSS feeds, product feeds, comma-separated value (CSV) feeds, etc., may be received by the processor 102 by executing the instructions 132. The processor 102 executes instructions 134 that determine values of the parameterized variables that are to be employed in generating and transmitting the dynamic digital content. In an example associated with emergency notifications, the parameterized variable values may include the notification reach, the notification transmission frequency, the target users and segments, the content of the notifications, etc. In an example wherein the dynamic digital content includes online advertisements, the parameterized variables may include campaign parameters/assets such as campaign spending, campaign types e.g., auction, brand, etc., campaign reach and frequency, Geo and time distributions, targeting audience and segments, situational creatives, campaign size and structure, and optimization goals such as traffic, leads, conversions, purchase, store visits, etc. For an offline advertisement campaign, the objectives may include, campaign parameters to be optimized to match the dynamic physical store availability, operating hours, inventory during a crisis/emergency, etc. The parameterized variables associated with the advertisement campaign may be part of the campaign setup. Another parameterized variable associated with the dynamic digital content transmission may include a selection of a particular channel based on infrastructure availability, bandwidth, situational coverage as cell signals or internet overage might be interrupted. This may include but is not limited to direct messaging, email, views from different surfaces (e.g., Whatsapp®, FB Messenger, Instagram, Blue App, etc.) based on telecommunication carrier's data feeds.

The processor 102 executes instructions 136 that identify one or more predefined rules and/or triggers to be applied based on the parameterized variable values. For example, a weather feed may indicate that the storm severity is reduced from 5 to 4. This may trigger the processor 102 to automatically generate a specific type of digital content e.g., an updated notification regarding the downgrade of the storm or to select another type of digital content such as an advertisement local to one of the storm-affected towns from the digital content data source 120 wherein the advertisement is selected and broadcast via one or more communication channels based on a geo-location feed associated with the severe weather. Furthermore, the user group who are to be informed regarding the status of the storm are also selected in addition to the transmission mode of the notification.

Instructions 138 are executed by the processor 102 to dynamically generate digital content for one or more of the user communications devices 192, 194, . . . etc. Referring again to the example of the traffic situation, the values from the traffic feed and the geo-location data may cause the processor 102 to dynamically generate an advertisement for vehicle insurance with values such as premiums, insured amounts, benefits, etc. determined based on the geo-location feed data. Thus, numerous advertisements may be generated on the fly from predetermined templates with different permutations and combinations of the parameterized variables. Based on the live updates from the data feeds, a specific notification or advertisement may be deactivated while another advertisement is selected or generated for transmission. Accordingly, it may be appreciated that the dynamic digital content served to different user communication devices 192, 194, . . . , etc. may be different based on the values provided by one or more of the feeds 152, 154, . . . , etc., and the selected rules.

The processor 102 executes instructions 140 to transmit the selected/generated dynamic digital content to one or more selected ones of the user communication devices 192, 194, . . . etc. The selection of the user communication devices to receive the dynamic content may be determined by matching the geo-location feed data and the location information of the user communication devices 192, 194, . . . etc. For example, as a storm moves through different areas, the updates tracking the storm may be provided to select audience at specific locations (e.g., the affected towns or counties) as opposed to a general broadcast to the public in a larger area (e.g., states) so that people receive more focused and pertinent information.

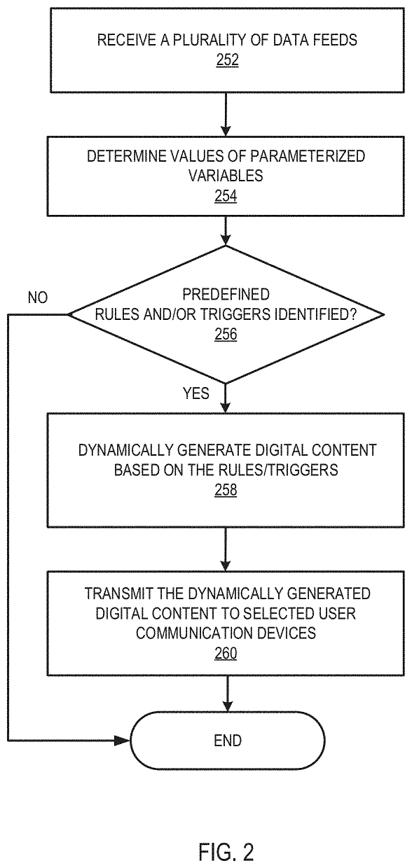

FIG. 2 shows a flowchart that details a method 250 of providing dynamic digital content according to an example. The method 250 may be executed by the processor 102 by accessing the computer-readable instructions 105 stored on the memory 104. The method begins at 252 wherein the processor 102 receives the plurality of data feeds 152, 154, . . . etc. At 254, the processor 102 determines the values of the parameterized variables that are to be employed in generating and transmitting the dynamic digital content. One or more variables may be determined at 254 for each data feed. For example, the weather data feed may be used to determine temperature, pressure, humidity, and other variables. The local information data feed may be used to populate variables such as the traffic at a geolocation, the various stores available, the operating hours of the stores, etc. For example, from posts or update feeds, the latest color, fabric and style trend data may be collected and aggregated for a particular geo area/demographic cohort. In this fashion example, color, fabric, style are parameterized variables with values populated from trending fashion data gleaned from tweeter data feeds.

When the parameterized variable values are determined, the processor 102 determines at 256 if one or more of predefined rules and/or triggers to be applied based on the parameterized variable values may be identified. If no rules/triggers could be identified at 256, the method terminates on the end block. If one or more rules are identified at 256, the digital content may be dynamically generated or selected from the digital content data source 120 by the processor 102 at 258 based on the triggers/rules. In an example, Artificial Intelligence (AI) bots may be used to select the rules to be applied which may affect one or more of the dynamic digital content generation and the audience group selection. The dynamic digital content is transmitted at 260 by the processor 102 to selected ones of the user communication devices 192, 194, . . . , etc. For example, artificial intelligence (AI) algorithms generates embeddings, or condensed knowledge, about an entity, such as a product, content, user, etc. When a user A comes to visit a store, the vast number of products available in the store are ranked, and only those products, say product B with their embeddings closest to the visiting user's embedding are filtered. Therefore, minimizing the vector distance between embedding (A) and embedding (B), effectively displays the most likely matched product (B) to a given user (A). While this on-the-fly product and user match is done very fast, the underlying embeddings are learned by the artificial intelligence (AI)/Deep Learning (DL) algorithms based on logged data about this user and product over the time, i.e. accumulated learned knowledge represented as embeddings, used to calculate distances in a vector space composed of these parameterized variables.

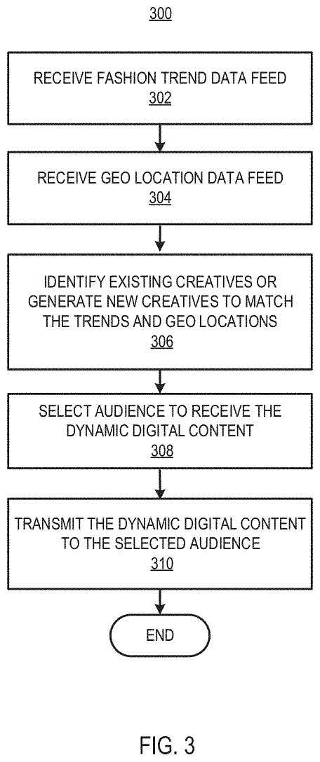

FIG. 3 details a method of providing dynamic digital content in the fashion segment according to an example. The processor 102 may receive fashion trend information at 302 from a third-party provider who provides fashion trend data via a data feed that provides constant fashion updates. These updates may include information regarding the trends in various categories such as men/women/kids clothing categories or accessory categories, footwear categories, etc. Also, the processor 102 may receive at 304, the geo-location feed associated with the fashion trend information so that the specific location at which a particular style is currently trending may be determined. At 306, the processor 102 may employ AI bots to identify existing creatives or generate new creatives that match the information received from the fashion and geo-location data feeds from an advertisement platform hosting the dynamic digital content data store 120 (which in this example would store a collection of advertisements). The audience to receive the advertisements are identified at 308 based, for example, on not only the geo-location data but also based on personal data such as user preferences, etc. The dynamic digital content is transmitted to the user communication devices of the selected audience at 310.

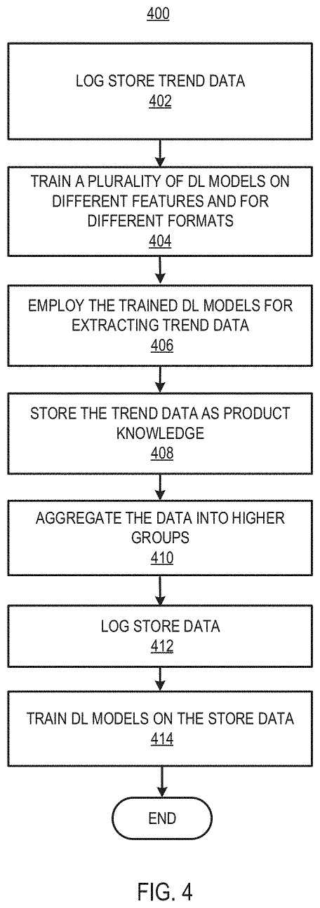

FIG. 4 shows a flowchart 400 that details a method of implementing trends for ads and stores per some examples. The method begins at 402 wherein store trend data comprising product browsing data and purchase transactions of a given merchant, such as a store are logged. In an example, the store may be an online store or a physical store and the product browsing data of the online store may be collected from user clicks, web feeds that may provide real-time data such as user comments, or data from any live online events featured by the store, etc. At 404, a plurality of Deep Learning (DL) models are trained on a combination of various features and for different data formats. In an example, the deep learning (DL)s may be trained on historical records with corresponding temporal identifiers to determine specific feature trends within corresponding time periods. The data formats may include audio, video, image, or textual formats. The features may include color, shape, texture, description, etc. For example, a deep learning (DL) may be trained on image data for extraction of features such as shape, whereas another deep learning (DL) may be trained to extract the color feature from video data, whereas yet another deep learning (DL) may be trained to extract descriptions from textual data using natural language processing (NLP) techniques. Therefore, a plurality of deep learning (DL)s are trained to extract specific product attributes from the trend data. The trained deep learning (DL)s are used to extract the product features from the store trend data at 406. The data thus extracted may be stored as product knowledge at 408. The extracted data is aggregated at 410 into higher levels such as but not limited to product groups, product families, product lines, catalogs, etc., to distill the corresponding level of product knowledge. Trend embeddings, of users and products, effectively create a trend graph, similar to social graph yet focusing on trends, with trend distances, emerging or fading trends timeline, trend leading/lagging indicators by geo regions, etc., all quantifiable and calculable on the fly. The trend data with its history may also be queried for trend study and research at aggregate levels.

The store data such as but not limited to ad statistics, shop traffic, shopping cart events such as completed transactions, abandoned carts, etc., transaction data, including purchases, exchanges, returns are also logged at 412. Again, deep learning (DL) models may be trained at 412 on the store data collected at 410 to capture users' preferences on different features such as colors, shapes, styles, etc. The deep learning (DL) models are therefore trained to identify trends for a combination of different factors. For example, when a user A is browsing for product B from a country C, etc., then the specific trend embedding of (A, B, C, . . . ) may be read or refreshed as needed based on a received user request.

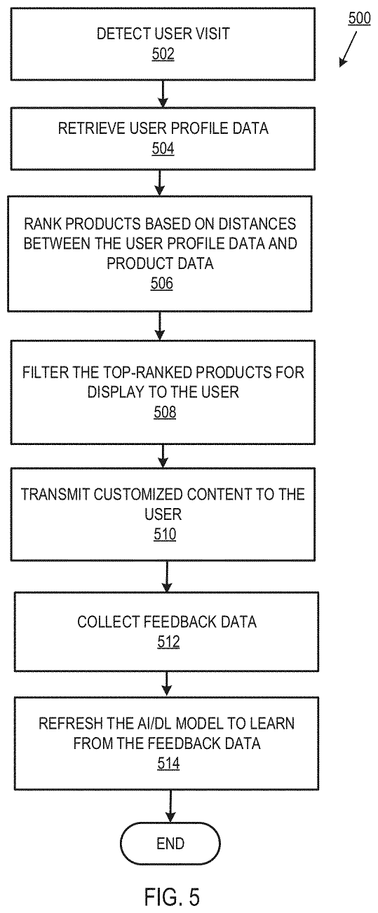

FIG. 5 shows a flowchart 500 that details a method of providing product recommendations in the dynamic, customized content according to an example. The method begins at 502 wherein a user's visit to a store is detected. The user may visit an online store or a brick-and-mortar store. The online store visit may be detected via a user log-in, cookies, or by using other programmatical techniques used to identify users to websites or mobile apps, etc., whereas users' visits to brick-and-mortar stores may be detected via users' location data, store cameras or other sensors. The user embeddings or user profile data is retrieved at 504 upon identifying the user. In an example, if the user cannot be individually identified a default profile may be associated with the user visiting a specific store location. In an example wherein the user is individually identified, the user data may include the user's social circle data so that the users' contact preferences may be factored into the user profile data. At 506, the products available for sale in the store may be ranked based on the distances between the user profile data and the product embeddings or product data. The user preference data from the user profile may be matched with the store trend data. For example, user trends and product trend embeddings may be matched using a two-tower model calculating embedding distances for the best experience. At 508, the top-ranked products may be filtered for display to the user. The content customized to the trend data that matches the user preferences may be thus identified or generated. Ads creatives may be customized based on the trend preferences of the user. When creating an ad for a targeted audience segment, trend embeddings from users in the targeted segment may be aggregated to select the best products and creatives featured in the ad. The customized content may be transmitted to the user at 510. For example, ads, including images, audio, or text data customized to the matching trend data may be identified. The ad impressions that are delivered may include but are not limited to text, description, language, call to action, friend's endorsements/likes/purchases, etc. The most trending product may be identified and the most trending creatives may be dynamically generated to deliver this unique customized ad impression to yield optimal results, influenced by the user's social circle. For window shopping consumers, products from trending shops with trending products and friends trend influences that best match consumer's tastes may be recommended via a product catalog that may be created virtually on the fly or the default storefront could be generated off aggregated trends from likes/fans for specific geolocation and demographic segments. In an example, only aggregated data may be shared among users to protect user privacy.

When designing a customized storefront, the trendiest product catalog may be generated to showcase to say visitors from different places thereby allowing users to identify trends at various geographic locales. In an example, the trendiest product catalog may include a dynamically ordered listing of products that are being discussed/purchased most as identified from the store trend data. As new store trend data is collected, the trendy product catalog may be updated dynamically. Furthermore, the store trend data when matched with the user preference data enables a merchant to present a user-specific trendy product catalog. Different content items such as an image may be transmitted concurrently with an audio content item so that both the items which pertain to trend data matching user preferences may be provided to the user simultaneously. In an example, the store trend data may be provided to an ad platform wherein the AI bots of the ad platform select suitable ads to be presented in response to the trend data. Successful conversions such as purchases may be used as positive training labels, while abandoned shopping carts as negative training labels, to enhance the deep learning (DL) models gravitating towards ever-changing patterns between products and users. Accordingly, the data collected from the user browsing history, purchase data, abandoned cart data, etc., may be collected as feedback at 512. The data thus collected at 512 may be employed to refresh the artificial intelligence (AI)/deep learning (DL) models that are used to match the user embeddings with the product embeddings at 514. Therefore, the artificial intelligence (AI)/deep learning (DL) models are updated and may learn from the latest user preferences.

The dynamic content delivery networks as described above may provide situational audience insights to help content providers, e.g., advertisers fine-tune their business and marketing objectives and better prepare for future situations.

Based on telecommunication situational coverage/bandwidth data feed and in respect of users' privacy preferences, the dynamic content delivery networks enable mobilizing social circles to locate a lost disaster victim or to help government agencies to identify pockets of areas that are not reachable.

In an example, the dynamic content delivery networks disclosed herein enable providing aggregated response maps that could be useful to auto-include/exclude from certain ad campaigns, or for government agencies to identify non-reachable “black hole” areas to effectively redirect resources to either arrive or avoid depending on the situations.

Referring again to the storm-related emergency example, a use case scenario is discussed below wherein dynamically generated digital content enables assisting those affected by the storm.

A hardware store may, instead of hard coding targeting criteria during campaign set up, specified dynamic campaign parameters and targeting criteria.

The targeting criteria and campaign parameters have Geolocation variables capable of receiving data feed from the National Weather Forecast Hurricane Center.

Digital content provider e.g., an advertiser may predefine rules specifying that once the Hurricane severity exceeds a certain threshold level, its ongoing campaign impressions delivered to affected areas (again based on data feed) will instead switch to:
i) Disaster relief settings in hurricane-impacted areas (national weather data feed) directing residents to offline stores (advertiser's data feed) during extended open hours on emergency merchandise, or divert them away from closed stores to nearby availability.
ii) Brand ads outside of hurricane-impacted areas (national weather data feed) for donations to help hurricane victims.
iii) Announcements from government agencies, e.g. FEMA, to direct residents to the nearest rescue centers.

The ad network or social network AI bots may operate to optionally connect victims with friends and family per user privacy settings, and/or connect with businesses such as property insurance companies to get potential damage claims started, e.g. upload pictures of damaged cars or houses, payment accounts set up, government relief fund disbursement, etc.

Situational campaign assets such as creatives may be provided by authorized agencies to plug into the campaign to best match the situational business objectives.

Options may be provided to allow ad networks to dynamically segment audiences and adjust campaign parameters based on authorized third-party data feeds. For example:

i) The situational data feed from the National Weather Service says Miami Fla. has a level 5 vs Tampa Fla. level 3. Brand campaign messaging targeting Miami vs Tampa might be different.

ii) Another example could be that the campaign optimization goals may be offline store visits before the hurricane storm vs disaster relief brand ads afterward, all based on authorized third-party data feed.

iii) Campaign budget allocations may be balanced among different areas based on hurricane impact distributions. Ad Network AI bots may adjust goals, creatives, reach, landing page, contents, audience segments, etc. based on dynamic data feeds such as weather services, or a list of names from government agencies, etc.

iv) Aggregated response maps may be useful for government agencies to identify flooded areas in order to effectively redirect disaster relief resources depending on the situation.

Furthermore, the integrated, closely-knit ads+shops platform makes real-time, large-scale, customized trend matching possible serving both merchants and consumers with substantial potential incremental revenue. This cycle feeds on itself to create stronger connections between ads and shops, forming an organic ecosystem, that both businesses and users benefit from its synergy, efficiency, and seamless experiences. It affords particular advantages to social media platforms like Facebook® where integrated ads and shops differentiate themselves from the competition. Further, payments could be another potential leg in this one-stop offering of the ads-shops-payment tripod to businesses. Trend embeddings, of users and products, effectively create a trend graph, similar to social graph yet focusing on trends, with trend distances, emerging or fading trends timeline, trend leading/lagging indicators by geo regions, etc., all quantifiable and calculable on the fly.

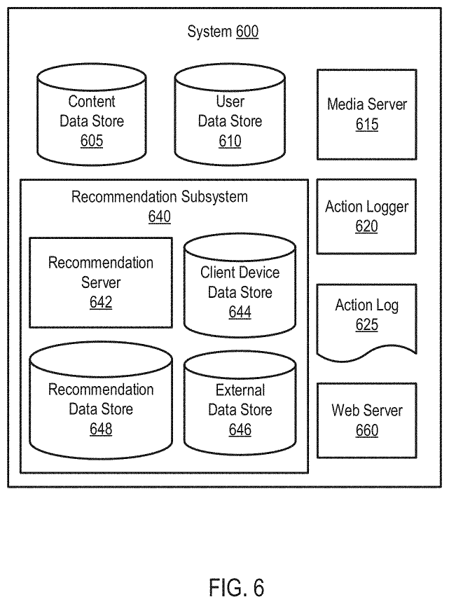

FIG. 6 illustrates a block diagram of a system 600 for providing recommendations, according to an example. It should be appreciated that the system 600 may be similar to the computer system 100 as described with respect with FIG. 1, but the system 600 may be described with more specificity and/or with examples of additional capabilities and features that may or may not be a part of computer system 100. In some examples, the system 600 may be an online system (e.g., a social media system) having a recommendation subsystem 640 to help provide search features as well as provide item recommendations for any number of user communications devices 192, 194 . . . , etc., communicatively coupled to the system 600 via the network 160. As shown, the system 600 may include a content data store 605, a user data store 610, a media server 615, an action logger 620, an action log 625, and a web server 660.

The content data store 605 may store a variety of content associated with an item trend within a search area, as described herein. As a result, the content data store 605 may involve any digital content associated with online activity of an item such as but not limited to searching, purchasing, adding to cart/wish list, etc., mapping a geography, etc. For example, such content may include digital content media associated with any number of items, such as events, directions, and/or other goods or services to be searched or recommended.

The user data store 610 may also store, among other things, data associated with users. This data may include user profile information directly provided by a user or inferred by the system 600. Examples of such information may include biographic, demographic, pictorial, and/or other types of descriptive information, such as employment, education, gender, hobbies, preferences, location, etc. It should be appreciated that any personal information that is acquired may be subject to various privacy settings or regulations, as described below.

The media server 615 may be used, among other things, to gather, distribute, deliver, and/or provision various digital media content, e.g., stored in the content data store 605 or elsewhere. The media server 615 may be used by system 600 to coordinate with the data feeds 152, 154, . . . , for example, which to facilitate processing of any item trend or provide recommendations to any number of client devices.

The system 600 may also include an action logger 620, an action log 625, and a web server 660. In some examples, the action logger 620 may receive communications about user actions performed on or off the system 100, and may populate the action log 625 with information about various user actions. Such user actions may include, for example, adding a connection to another user or entity, sending a message from another user or entity, viewing content associated with another user or entity (such as another user or an advertisement), initiating a payment transaction, etc. In some examples, the action logger 620 may receive, subject to one or more privacy settings or rules, content interaction activities associated with another user or entity. In addition, a number of actions described in connection with other objects may be directed at particular users, so these actions may be associated those users as well. Any or all of these user actions may be stored in the action log 625.

The system 100 may use the action log 625 to track user actions on the system 100 or other external systems. The action log 625 may also include context information associated with context of user actions. For example, such context information may include date/time an action is performed, other actions logged around the similar date/time period, or other associated actions. Other context information may include user action patterns, patterns exhibited by other similar users, or even various interactions a user may have with any particular or similar object. These and other similar actions or other similar information may be stored at the action log 625, and may be used for calculating a search radius based on density using map tiles and/or providing recommendations using the search radius, as described herein.

The web server 660 may link the system 600 via a network (e.g., network 160 of FIG. 1A) to one or more user communications devices 192, 194 . . . , etc. The web server 660 may serve web pages, as well as other web-related content, such as Java, Flash, XML, or other similar content. The web server 660 may communicate with various internal elements of the system 600 or external network components to provide various functionalities, such as receiving, transmitting, and/or routing content between the system 600, client devices, and other network elements or components.

As described herein, the system 600 may also include the recommendation subsystem 640. The recommendation subsystem 640 may employ one or more techniques to help define, modify, track, schedule, execute, compare, analyze, evaluate, and/or deploy one or more applications for the system 600. In some examples, the recommendation subsystem 640 may also employ any variety of techniques to provide item recommendations, for instance, using information from client devices, external system 160, or other network elements (not shown) of the system environment 150. In some examples, the recommendation subsystem 640 may include a recommendation server 642, a client device data store 644, a host system data store 646, and a recommendation data store 648.

In particular, the recommendation server 642 of the recommendation subsystem 640 may enable the system 600 to provide any number of item recommendations to user communications devices 192, 194, . . . , etc., as discussed herein. Specifically, the recommendation server 642 may, in some examples, analyze, evaluate, examine, and/or update data associated with any trend received with one or more of the data feeds 152, 154, . . . etc., for an item in or near any geographical area associated with the trend. Based on these assessments, the recommendation server 642 may identify and/or recommend various items for the user communications devices 192, 194, . . . , etc., where these items may include, but not limited to, events, such as musical events, art events, culinary events, etc.

The recommendation subsystem 640 may use the client device data store 644 to store content associated with user communications devices 192, 194, . . . , etc., and the recommendation data store 648 to store content associated with data and/or any information derived from such any search query or other relevant data, such as recommendation data, historical data, etc.

Although not depicted, it should be appreciated that system 600 may also include various artificial intelligence (AI) based machine learning tools to help provide item recommendations. For example, these AI-based machine learning tools may be based on optimization of different types of content analysis models, including but not limited to, algorithms that analyze data and potential search results, and other details to provide relevant item recommendations. For instance, these AI-based machine learning tools may be used to generate models and/or classifiers that may include a neural network, a tree-based model, a Bayesian network, a support vector, clustering, a kernel method, a spline, a knowledge graph, or an ensemble of one or more of these and other techniques. These AI-based machine learning tools may further generate a classifier that may use such techniques. The recommendation subsystem 640 may periodically update the model and/or classifier based on additional training or updated data associated with the system 600. It should be appreciated that the recommendation subsystem 640 may vary depending on the type of input and output requirements and/or the type of task or problem intended to be solved. The recommendation subsystem 640, as described herein, may use supervised learning, semi-supervised, and/or unsupervised learning to build the model using data in the training data store. Supervised learning may include classification and/or regression, and semi-supervised learning may require iterative optimization using objection functions to fill in gaps when at least some of the outputs are missing. It should also be appreciated that the recommendation subsystem 640 may provide other types of machine learning approaches, such as reinforcement learning, feature learning, anomaly detection, etc.

In some examples, the system 600 may provide a manual mode of operation, where a user may narrow down selection with limited or without use of the recommendation subsystem 640 so that user searches are combined with the trend recommendations. For instance, the user may search for items within the trend recommendations by a sorting feature, as follows: Content Type>Category>Sort by Name>Sort Items Within 100-Mile Radius>Sort by Reviews. In some examples, the system 600 may provide a search feature that may use natural language processing (NLP) or other similar search function to accept user search inputs. In this way, a user may be presented with a list of item recommendations, but may use the search feature to refine his or her search. For example, as the user types his or her desired event, etc., the list of recommendations may be continuously and/or automatically refined based on the user's input. For example, if the user enters “S” into the search feature, the recommendation subsystem 640 may narrow the list of recommendations to those events that begin with the letter “S.” If the user continues typing the user search input and enters “Swing” into the search feature, the recommendation subsystem 640 may narrow the list of recommendation to ones that begin or have the word “Swing.” Other various similar or different features may also be provided.

It should be appreciated that classification algorithms may provide assignment of instances to pre-defined classes to decide whether there are matches or correlations. Alternatively, clustering schemes or techniques may use groupings of related data points without labels. Use of knowledge graphs may also provide an organized graph that ties nodes and edges, where a node may be related to semantic concepts, such as persons, objects, entities, events, etc., and an edge may be defined by relations between nodes based on semantics. It should be appreciated that, as described herein, the term “node” may be used interchangeably with “entity,” and “edge” with “relation.” Also, techniques that involve simulation models and/or decision trees may provide a detailed and flexible approach to providing item recommendations associated with calculating a search radius based on density, as described herein.

It should be appreciated that the systems and subsystems, as described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the processors, systems, subsystems, and/or other computing devices may be shown as single components or elements (e.g., servers), one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100 and/or 600.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

Digital content is any information that exists in the form of digital data. Also known as digital media, digital content is stored on digital or analog storage devices in specific formats. Forms of digital content include information that is digitally broadcast, streamed, or contained in computer files. Online systems such as social media platforms, search engines, online digital content portals, etc. may have different types of users including opt-in users who allow the online systems to track them on the internet and collect their data so that they may receive customized content, rewards/incentives, or other benefits. However, a larger number of users may include opt-out users who would prefer to keep their identities private while accessing online platforms/services. While the opt-out users may accept subscriptions, advertisements, or other modes to pay for their services, tracking the effectiveness of digital content such as advertisements provided to such users may pose a technical challenge. Furthermore, the introduction of privacy measures and regulations related to tracking and collection of data from online users increasingly put low entropy constraints on online advertising.

In this context, “low entropy,” generally measures the expected or average amount of information conveyed by identifying the outcome of a random trial, as used herein and throughout, may refer to a limited amount of information allowed to be passed back to a platform for content provisioning/distribution (e.g., advertising platform) on the content itself, content performance, device, user, internet protocol (IP) address, location, etc. after the content was served to the user due to constraints imposed by systems running on the device controlled by the device vendors. In this way, this may cut off the feedback loop to the advertising platform and advertisers with limit on the amount of pass back information gated by what specific data and sequence of events allowed number of bits in each data element, shortened event time window, random timing of when data can be sent, etc. with the number of bits even lowered in unspecified circumstances as controlled by the device vendor (even lower entropy).

It should be appreciated that information entropy may generally refer to measuring an expected or average amount of information conveyed by identifying an outcome of a random trial. In this context, each content item that is provided may be considered a trial with random outcome further constrained by a device. Thus, the amount of information eventually passed back to the content provider post constraints imposed by the device may be lower compared to environments or scenarios without such constraints.

The aforementioned low entropy online content constraints may disable targeted content delivery exclusion due to newly imposed constraints of device vendors resulting in low entropy unless: a) Users explicitly opt-in, or b) Content providers such as advertisers explicitly share user data with other partners such as ad networks from the Customer Relationship Management (CRM) systems. However, such sharing may not occur in real-time. As a result, a technical problem arises in online content delivery networks wherein digital content items can still be delivered to a user multiple times even if the user has already viewed and acted on the content, e.g., made a purchase, recommendation, etc. This may lead to waste of network resources while worsening the performance of the content personalization services thereby resulting in bad user experiences due to over-targeting.

Systems and methods for online delivery of digital content items based on user-provided feedback are disclosed. The user (who may be an opt-out user) may receive a digital content item displayed on a user device wherein the digital content item enables the user to provide feedback related to the digital content item. The feedback provided by the user may include at least exclusion data and action-taken data. In either case, it may signify that the user does not wish to receive the digital content item again. In addition, the user may be enabled to provide feedback with different options. A feedback option may allow the user to convey that the user would like to block/exclude the specific digital content item received by the user or digital content items that are similar to the specific digital content item. Another feedback may pertain to whether the user would like to exclude digital content items from the same content source. Furthermore, the feedback data may further include reasons for the user's exclusions e.g., action-taken data. In an example, the user may indicate that the user has already taken action in response to the received digital content item. For example, in response to an advertisement for a car, the user may provide information regarding the user's recent car purchase so that the user no longer receives digital content items such as ads related to cars. The user's feedback may be recorded in an exclusions list stored in a corresponding user profile.

The feedback data from the user may be employed to train machine learning (ML) models for digital content filtering so that the users' exclusions may constitute negative label data while digital content items related to action-taken feedback may be used as positive label data for training the machine learning (ML) models. Therefore, the systems and methods according to examples herein avoid over-targeting users with customized content. Additionally, processes to provide incentives may be instituted to encourage users to provide feedback to the digital content items so that relevant digital content items are served to users while complying with the low entropy constraints imposed by various entities in communication networks.

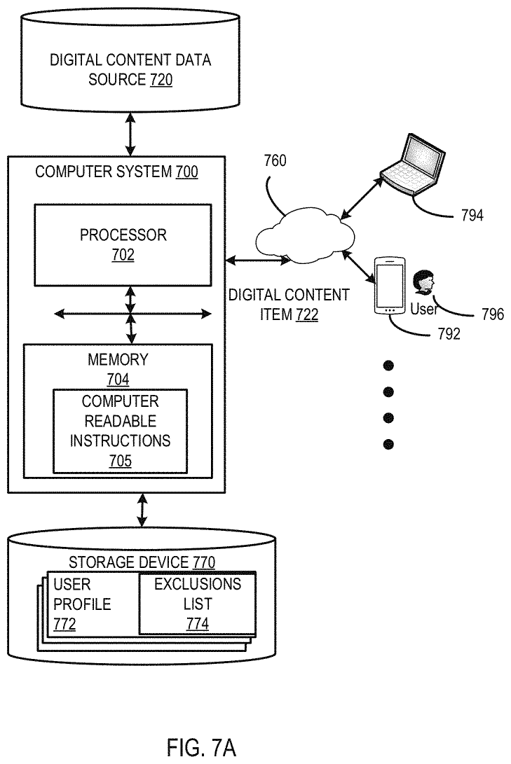

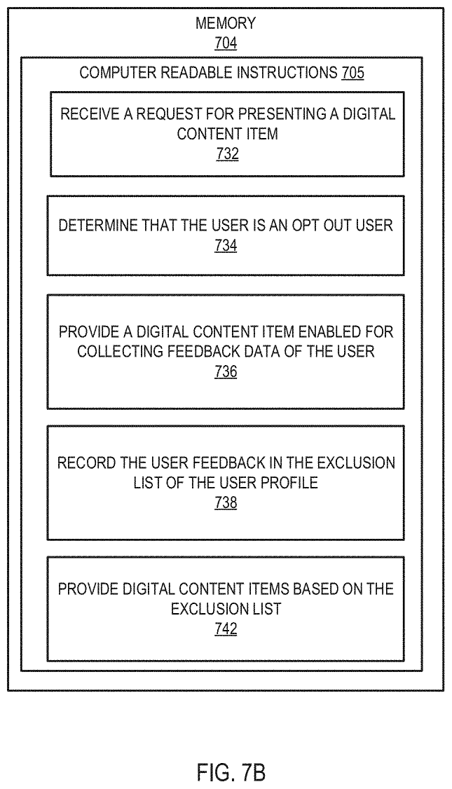

Reference is now made with respect to FIGS. 7A and 7B which illustrate a block diagram of a computer system 700 and a memory 704 included therein that is used for customization and transmission of digital content, according to an example. As shown in FIG. 7A the computer system 700 may include a processor 702 and a memory 704. FIG. 7B illustrates a block diagram of the memory 704 including computer-readable instructions 705, that when executed by the processor 702 may be configured to customize and deliver digital content over user communications devices 792, 794, . . . , etc., according to an example. The user communication devices may be electronic or computing devices configured to transmit and/or receive data (e.g., via a social media application), and in one example, the user communication device 792 may be a smartphone, and the user communication device 794 may be a laptop.

The computer system 700 may communicate with the user communication devices 792, 794, . . . , etc., via a network 760 that may be a local area network (LAN), a wide area network (WAN), the Internet, a cellular network, a cable network, a satellite network, or another network. Network 760 may further include one, or any number, of the exemplary types of networks mentioned above operating as a stand-alone network or in cooperation with each other. For example, the network 760 may utilize one or more protocols of one or more clients or servers to which they are communicatively coupled. Network 760 may facilitate the transmission of data according to a transmission protocol of any of the devices and/or systems in the network 760. Although network 760 is depicted as a single network, it should be appreciated that, in some examples, the network 760 may include a plurality of interconnected networks as well.

It should be appreciated that the systems and subsystems as shown herein, and as described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the servers, systems, subsystems, and/or other computing devices may be shown as single components or elements, it should be appreciated that one of ordinary skill in the art would recognize that these single components or elements may represent multiple components or elements and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the computer system 700 or the system environment including the computer system 700, the user communication devices 792, . . . , etc., and the digital content data source 720.

The computer system 700 may further include the storage device 770. In one example, the storage device 770 may include any number of servers, hosts, systems, and/or databases that store data to be accessed by the computer system 700 or other systems (not shown) that may be communicatively coupled thereto. Also, in one example, the servers, hosts, systems, and/or databases of the storage device 770 may include one or more storage mediums storing any data, and may be utilized to store information (e.g., user information, demographic information, preference information, etc.) relating to users of a social media application facilitating the generation and transmission of dynamic digital content. In an example, the storage device 770 may store user profiles 772 including user information for each user such as but not limited to user id and an exclusions list 774. The exclusions list 774 may include IDs of digital content items such as advertisements that are not to be presented to the user. For example, digital content items which are already viewed by the user and disliked or digital content items which the user may have indicated that action was already taken may be added to the exclusions list 774. Presenting digital content items disliked by the user or on which the user has already acted may lower the user experience. The computer system 700 may also be communicatively coupled to a digital content data source 720. In another example, the digital content data source 720 may be a part of a digital content platform that supplies digital content on demand. The processor 702 in the computer system 700 may access the computer-readable nstructions 705 from the memory 704 to execute various processes that enable the transmission of digital content items as described herein. In an example, the digital content item 722 may include an advertisement for products and/or services. An exclusions list in each user profile may include identifiers of one or more of the digital content items 772 that may not be presented to a user associated with the user profile 772.

In one example, the memory 704 may have stored thereon machine-readable instructions (which may also be termed computer-readable instructions) that the processor 702 may execute. The memory 704 may be an electronic, magnetic, optical, or another physical storage device that contains or stores executable instructions. The memory 704 may be, for example, Random Access Memory (RAM), an Electrically Erasable Programmable Read-Only Memory (EEPROM), a storage device, an optical disc, or the like. The memory 704, which may also be referred to as a computer-readable storage medium, maybe a non-transitory machine-readable storage medium, where the term “non-transitory” does not encompass transitory propagating signals.

More particularly, the processor 702 may execute instructions 732 to receive a request for presenting a digital content item to a user device, e.g., the user device 792. In an example, the request for presenting the digital content item may include identifying an opportunity to present the digital content item to the user device 792. The opportunity for the presentation of the digital content item may include the user accessing a webpage, an application, or another online resource. The processor 702 may execute instructions 734 to determine that the user is an opt-out user (e.g., user 796) who has opted out of providing identifying or profiling information to online services such as those offered by the computer system 700 such as a social media service, a messaging service, etc. When the user opts out, user privacy needs to be considered while identifying relevant digital content items to be presented to the user. If the user opts-in, then user profiling information may be collected and used for at least digital content presentation.

The processor 702 may execute instructions 736 to provide a digital content item 722 enabled for collecting feedback data on the user device 792. The user 796 may provide feedback regarding whether the digital content item 722 may be added to the exclusions list 774 in the user profile 772 associated with the user 796. Particularly, the user 796 may be enabled to provide feedback regarding whether the user 796 wishes to receive similar digital content items or digital content items from the same source e.g., advertisements from the same advertiser.

Various options are discussed below for an example wherein the digital content item 722 may include an advertisement. The digital content item 722 may include a link such as “Why I Am Seeing The Ad” (WAIST), an overlay, or other user interaction mechanism that allows the user navigation to a tool to manage digital content item preferences. A screen/tab may allow the user 796 to select from one or more options which may include 1) Action already taken/already purchased, 2) Repeated digital content, and 3) Don't like this digital content item. Another tab/screen of the tool may allow the user 796 to choose one of 1) Take me off from this ad 2) Take me off this and similar ads and 3) Take me off all ads from this advertiser. When the user 796 selects option (1) to “Take me off from this ad”, it may translate to exclude the user 796 from that ad and all ads from the same ad set which may have been created from the permutations/combinations of contents of the digital content item 722 by varying creatives, contents, image/video formats, colors, durations, frame ratio, other degrees of freedom. The selection of option (1) may add the user 796 explicitly to the highest ad structure, say ad set, applicable to all ads and variations of the ads. Therefore, qualified ads may not be delivered to the user per the explicit entries in the exclusions list 774. When the user 796 selects option (2) to “Take me off this and similar ads”, it may translate to the same scope as “Take me off from this ad” plus “similar ads”. Machine learning (ML) techniques are described herein that may be implemented for identifying similar ads. Advertisers may configure product similarities metrics to be used by machine learning (ML) for example by manually grouping similar products, grouping automatically by product proximity in product catalog/hierarchies, or via ad network's default similarity options. Selection of option (3) by the user 796 to “Take me off all ads from this advertiser”, may exclude the user from this ad and all ads from the same advertiser account and may be optionally applied to advertiser or agency accounts belonging to the same entity. This exclusion may be applied at either ad account or entity account level for complete exclusion for the user 796. Qualified ads may not be delivered to the user per explicit entries in the exclusions list 774. The tool may further enable the user 796 to enter the user ID information and consent to the usage of the entered data for targeting exclusions purposes i.e., for recording entries in the exclusions list 774 associated with the user profile 772.

The processor 702 may execute instructions 738 to record the user feedback to the digital content item 722 in the exclusions list 774. The digital content item provider such as an advertiser may obtain explicit permission from the user and record the information intended for purposes such as regulatory compliance and auditing. The information or feedback data that may be stored in the exclusions list 774 may include a triplet of the form (userID, itemID, preferences), wherein the user ID may be explicitly provided by the user, the exact item ID identifiable as the user may have clicked on WAIST on receiving the digital content item 722 and the preference may include the user's choice related to the digital content item 722, similar digital content items and the digital content items from a specified content provider/digital content source.

The processor 702 may execute computer readable instructions 742 to provide filtered digital content items based on the exclusions list 774 recorded in the user profile 772. In an example, whenever a digital content item is to be presented to the user 796, the processor 702 may retrieve the exclusions list 774 to determine if the digital content item to be presented is included therein. As mentioned above, the verification depends on the preferences recorded in the exclusions list 774. The digital content item may be suppressed from being presented to the user if it is explicitly recorded via a corresponding itemID in the exclusions list 774. The digital content item may be suppressed if it is determined to be similar to other/prior digital content items which the user has excluded from the presentation and the user preferences indicated that similar items are to be excluded in the feedback data defined above. The digital content item may also be suppressed if it is determined that the digital content item is from a content source that was indicated by the user 796 as being excluded. Digital content items thus filtered as being dissimilar to the digital content item 722 and therefore not included in the exclusions list 774 are presented to the user 796. Alternately, if the digital content item does not meet any of the exclusion preferences of the user 796 as laid out in the exclusions list 774 it may be presented to the user 796.

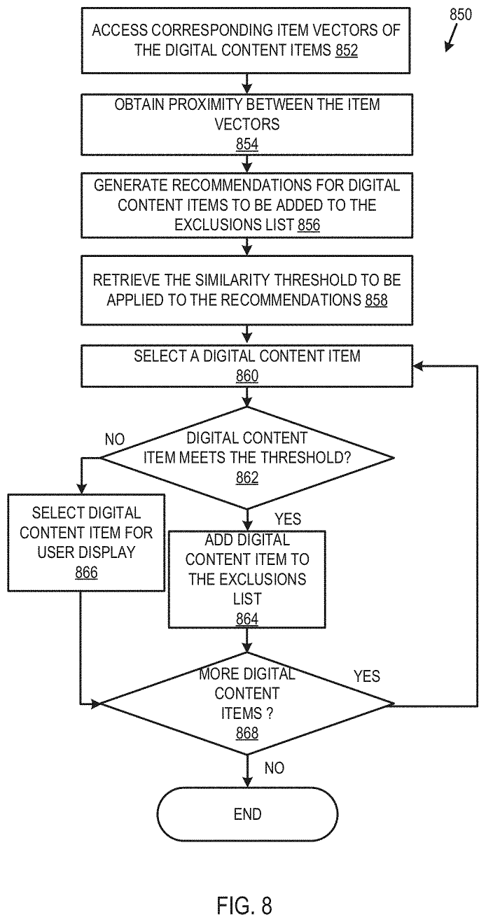

FIG. 8 shows a flowchart that details a method 800 of determining similarity between digital content items according to an example. The method 850 may be executed by the processor 702 by accessing the computer-readable nstructions 705 stored on the memory 704 to determine if a digital content item may be presented to the user 796. Method 850 may begin at 852 wherein the processor 702 accesses the corresponding item vector(s) representing one or more digital content item(s) to be compared for similarity to the digital content item 722. For example, when executing the computer readable instructions 742 to determine whether or not a set of digital content items are similar to the digital content item 722 added to the exclusions list 774, the processor 702 may initially access the corresponding item vectors of the digital content items including the digital content item 722 for which the similarity is to be determined. The item vectors may include an array of attributes of the digital content items that may be compared for similarity determination purposes. The attributes in an item vector of a digital content item may include but are not limited to, classification of the digital content item under various categories, the actual content of the digital content item, properties of the digital content item such as but not limited to, format, size, creation date, etc., of the digital content item, etc.

At 854, the proximity between the digital content item(s) may be obtained by using unsupervised learning techniques such as clustering in an example. In another example, the proximity between the digital content items may be obtained via supervised learning techniques such as nearest neighbor technique. If the digital content items pertain to advertisements, the supervised or unsupervised learning may be based on advertiser-provided catalogs or hierarchies. At 856, recommendations regarding the digital content items to be added to the exclusions list 774 which are to be suppressed from presentation to the user 796 may be generated using, for example, collaborative filtering techniques. In an example, collaborative filtering may be based on aggregated content item statistics and the WAIST statistics. At 858, the similarity threshold configured for the recommendations may be retrieved. The similarity threshold may be configured from digital content items such as look-alike ads from seeded as of the user 796, or ads from similar users. The similarity threshold may be based on metrics such as but not limited to precision, recall, accuracy, F1, or other proprietary measures.

At 860, one of the digital content items may be selected for determining if it should be added to the exclusions list 774. It is determined at 862 if the digital content item meets the similarity threshold. If yes, the digital content item may be added to the exclusions list 774 at 864 and may not be presented to the user 796. If it is determined at 862 that the digital content item does not meet the similarity threshold, the digital content item may be selected for presentation to the user at 866. It is determined at 868 if further digital content items remain for similarity determination. If yes, the method returns to 860 to select the digital content item, else the method terminates on the end block.

It may be appreciated that the determination regarding the addition of the digital content items to the exclusions list 774 is described herein as occurring serially for illustration purposes only and that the digital content items may be processed in parallel for similarity determination in accordance with certain examples. Furthermore, comparison of the digital content items with a single digital content item, i.e., the digital content item 722 is described for illustration purposes only, it can be appreciated that the exclusions list 774 may include multiple exclusion vectors i.e., item vectors corresponding to user-selected digital content items to be excluded from display. The digital content items may be similarly compared to each of the exclusion vectors serially or in parallel as detailed above to identify specific digital content items that may be added to the exclusions list 774 or displayed to the user 796. In an example, the exclusion data from the exclusions list 774 may be used negative labels to train machine learning (ML) models such as neural networks (NN) to accurately capture user preferences in digital content. The training results may be captured in the exclusions list 774 as user exclusion vectors in the form of triplets and may be retrieved when finding and ranking personalized digital content.

In an example, the processor 702 may execute further instructions to incentivize users to provide feedback regarding their digital content preferences such as one or more of exclusion data, action-taken data, etc. Users may share conversions (e.g., purchases, actions such as recommendations/references, likes, signups, etc.) with the digital content source/provider to earn incentives. Therefore, the digital content source gains loyal users with tighter engagements, users gain better user experience and digital content providers such as advertisers can gain deep funnel online or offline conversion information to better optimize the content delivery process. The incentives provided may take many forms including but not limited to:
i. $X credits towards next purchase(s),
ii. $X credits towards loyalty program(s),
iii. $X credits towards online purchase e.g. online shops, games, Virtual Reality content, etc.,
iv. $X credits towards offline shops (i.e. a nearby physical store),
v. X credits towards product warranty,
vi. Extra $X credits if online/offline purchases validated,
vii. Ad network tokens redeemed for fewer ads, and
viii. Virtual currency available, such as game tokens, virtual money, etc.

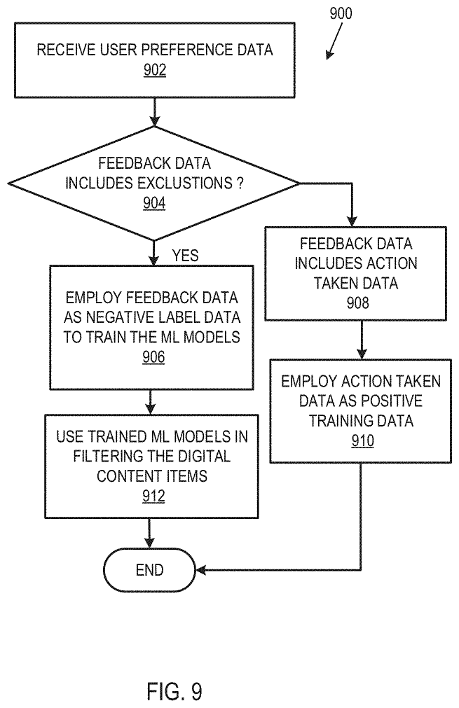

FIG. 9 shows a flowchart of a method 900 to build user profiles according to some examples. The information provided by the users may be used to train machine learning (ML) models that represent user preferences to filter the digital content items to be presented to the users. The user preference data may be received from the user 796 at 902 via the tool. The tool may enable users to provide different types of user preference/feedback data which may include exclusions or action-taken. At 904, it is determined if a received feedback data includes exclusions. If yes, the feedback data may be employed at 906 as negative label data to train one or more machine learning (ML) models so that the specific digital content item and other similar digital content may not be displayed to the user 796. As described above, the user feedback data may specify if similar digital content items or digital content from the same content source may be blocked or excluded.

If it is determined at 906 that the feedback data is not exclusion data then, it may be determined at 908 that the feedback data includes action-taken data. In case the digital content item pertains to an advertisement, the action taken may include making a purchase in response to viewing the advertisement. Therefore, the action-taken data received at 908 may be used as positive training data for the machine learning (ML) models at 910. The machine learning (ML) models thus trained are used at 912 in filtering the digital content items to be presented to the users of the system 700.

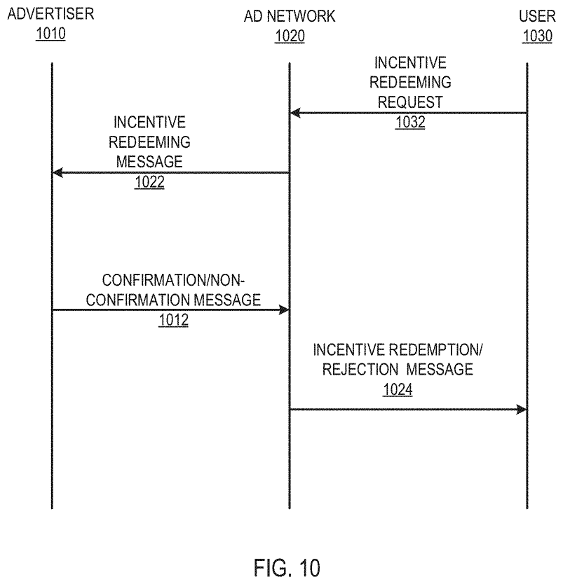

FIG. 10 shows a data flow diagram 1000 for content-providing networks such as advertising networks to enable the user 196 to request incentives according to an example. While a specific use case for advertising networks is illustrated herein, it can be appreciated that similar processes may be implemented in other digital content-providing networks also. The user 1030 may send a request 1032 to the ad network 1020 to redeem an incentive. The ad network 1020 may transmit an incentive redeeming message 1022 to the advertiser regarding the incentive redeeming request 1032 transmitted by the user 1030. The advertiser 1010 may confirm (e.g., with a backend database, etc.) if the incentive can be provided e.g., if an action such as a purchase, a recommendation, etc., was indeed executed by the user 1020. Upon receiving the confirmation/non-confirmation, an appropriate response 1012 may be provided by the advertiser 1010 to the ad network 1020. The ad network 1020 may forward the incentive redemption/rejection message 1024 to the user 1030. When a user chooses to send a request or receive confirmation via message, ad networks such as Facebook may use messaging applications such as WhatsApp® or other user-provided communication modes to connect the user and the advertiser, possibly engaging for more direct person-to-advertiser interactions. The confirmation from the ad network 1020 may include confirmation of targeting exclusion preferences and receipt of earned incentives with copies to both the user 1030 and the advertiser 1010. Ad networks 1020 may be able to report to both the user 1030 and the advertiser 1010 aggregated incentives for requested durations with backend integration to the advertiser to keep the balance up-to-date. If applicable, an option may be provided for the user 1030 to cash out on the accumulated credits towards future purchases/conversions in line with specifications as provided by the advertiser 1010 specified in a campaign setup. The incentives applied towards future conversions may show up on the bill reflecting the cash out and new balance. In an example, the ad network 1020 may also provide incentives such as tokens or rewards to users to share online/offline conversions. Such ad network tokens may be redeemed by users for various rewards such as but not limited to: (i) fewer ads during a specific time; (ii) gift tokens to friends/family; (iii) donations to preferred charities; and (iv) save to virtual currency wallets.

In an example, the rewards may be stored by the users in wallets and the users can use the virtual currency to gift, done, pay for a purchase, checkout purchases, etc., where applicable.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content”, “digital content”, “digital content item” and “content item” may refer to any digital data (e.g., a data file). Examples include, but are not limited to, digital images, digital video files, digital audio files, and/or streaming content. Additionally, the terms “content”, “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers, such as vendors looking to advertise a good or service, engage users with content of interest. As a result, content providers are continuously looking for ways to deliver more appealing content.

In some instances, digital advertising may be an appealing option due to its immediate, inexpensive and versatile nature. For example, small businesses with limited budgets may find digital advertising appealing because it may offer an opportunity to direct limited resources in a highly-targeted manner to potential customers. So, in one example, a vendor may generate an advertising content item to engage potential customers and may distribute the advertising content item over a content platform (e.g., a social media platform) to make users aware of their product.

However, digital advertising may also come with its own drawbacks. For example, while an advertising content item may enable sales associates to provide information that may lead to a sale, the advertising content item may also in certain circumstances be of limited use due to its static (i.e., unchanging) nature. For example, in some instances where sales associate may require customized (i.e., unique) messaging to reach one or more potential customers, the sales associate may unable to do so. Another drawback of digital advertising may be that creation of a content item may require excessive amounts of “post-processing”. Examples, of post-processing may include editing, addition of effects and formatting. In many instances, content creators may not have skills required to generate professional-quality content. Furthermore, enlisting help from those with the required skills may be costly and time-consuming as well.

Systems and methods described may provide real-time generation of content according to a specified template using a real-time rendering ecosystem utilizing augmented reality (AR) techniques which may enable users to plurally and uniformly generate content. In some examples, the systems and methods may enable a creating user to input specifications for a template that may be used to generate content by one or more publishing users. As used herein, a “creating user” may include any user that may generate a template providing a supplemental effect in generation of a content item. An example of a creating user may be a vendor seeking to generate content items to sell a product or service. As used herein, a “supplemental effect” may include any specified aspect that may be added to a content item. In some examples, the supplemental effect may be added in real-time during generation of the content item by a publishing user. Also, as used herein, a “publishing user” may include any user that may utilize a template generated by a creating user to generate a content item. An example of a publishing user may be a sales associate generating content items in order to sell a product or service on behalf of a vendor (i.e., a creating user).

In some examples, the systems and methods may enable a creating user to input customized specifications for a template. Examples of these customized specifications may include color, font, theme, etc. In some examples, the customized specifications may be utilized to generate one or more supplemental effects that may be implemented uniformly during real-time processing of content generated by one or more publishing users.

In some examples, the systems and methods may generate an access item that may provide access to a template implementing supplemental effects to creating users. In some examples, the access item may be a universal resource locator (URL) link. So, in some examples, the systems and methods described may deliver an electronic communication (e.g., an email) that may enable a creating user to download a file that may provide access to the access item. In some examples, the access item may then be utilized to enable publishing users to generate content items according to the template-based supplemental effect.

In some examples, the systems and methods may leverage augmented reality (AR) processing techniques to provide real-time, template-based rendering(s) of a content item with one or more supplemental effects. In particular, in some examples, the systems and methods may include a rendering ecosystem employing augmented reality (AR) techniques. As used herein, a “rendering ecosystem” may employ any number of executable instructions on a computer memory that may enable processing of received content (e.g., real-time streaming video) according to a specified template and generation of a content item with one or more supplemental effects. So, in one example, the rendering ecosystem may receive content data streamed in real-time by a publishing user, and may utilize augmented reality (AR) techniques to generate a content item having a template-based supplemental effect.

Accordingly, upon receiving customized specifications for the template from a creating user, the systems and methods may enable publishing users to utilize the template to generate uniform, high-quality content according to the customized specifications. In some examples, the systems and methods may provide an electronic distribution system that may be utilized by creating users to distribute a template that may enable publishing user to generate a content item with a template-based supplemental effect. So, in some examples, a creating user may upload and distribute a universal resource locator (URL) link to one or more publishing users that may provide access to the template. In some examples, the universal resource locator (URL) may open directly into a content platform (e.g., a social media platform), and may enable a publishing user to generate the content item with the template-based supplemental effect in real-time via use of a rendering ecosystem.

The systems and methods described herein may be implemented in various contexts. For example, the systems and methods may enable creating users (e.g., vendors) to leverage high-quality processing techniques that may enable associates to produce high-quality, customized content in a consistent manner. Moreover, the systems and methods may enable publishing users (e.g., sales associates advertising a product) to each individually access a rendering ecosystem to generate high-quality content in real-time and in a uniform manner. Furthermore, the systems and methods may enable content platforms to provide high-quality and consistent content to users. Accordingly, in some instances, the systems and methods may obviate a need for dedicated post-processing and may reduce cost, time and effort required in creation of content items.

It should be appreciated that while the examples described herein may relate primarily to advertising and content generation in advertising, the systems and methods described may have numerous other applications as well. For example, a rendering ecosystem may be utilized to provide supplemental effects relating to any content item that may be processed using augmented reality (AR) techniques. In some examples, the rendering ecosystem may be utilized in supplementing consumption of published content. In particular, in one example, a publishing user publishing a video from a golf tournament may provide trajectory and distance information (i.e., supplemental effects) in real-time.

Although the methods and systems as described herein may be directed to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

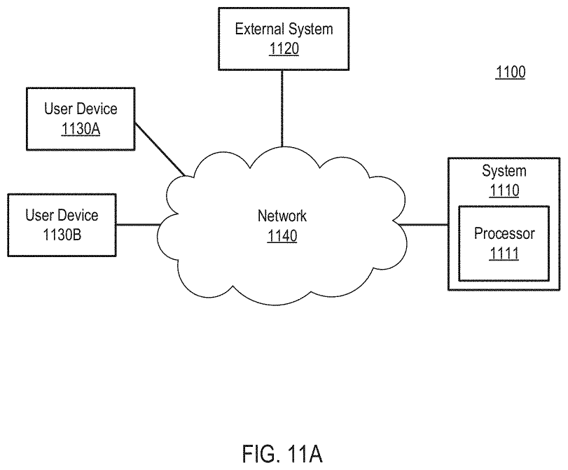

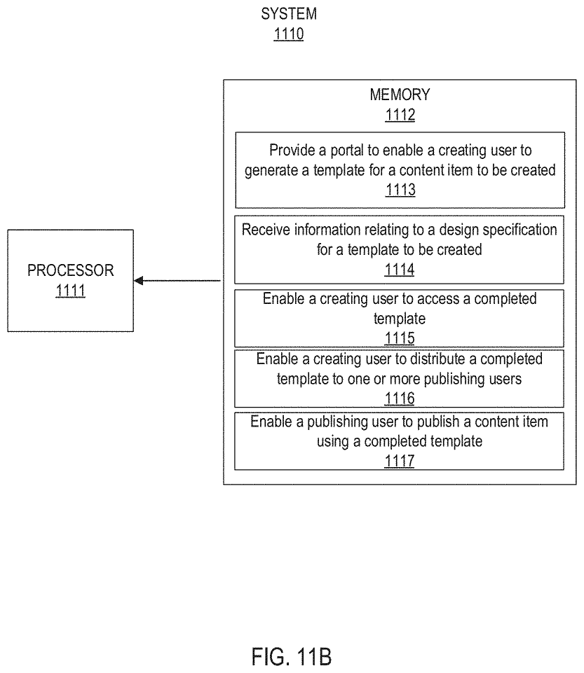

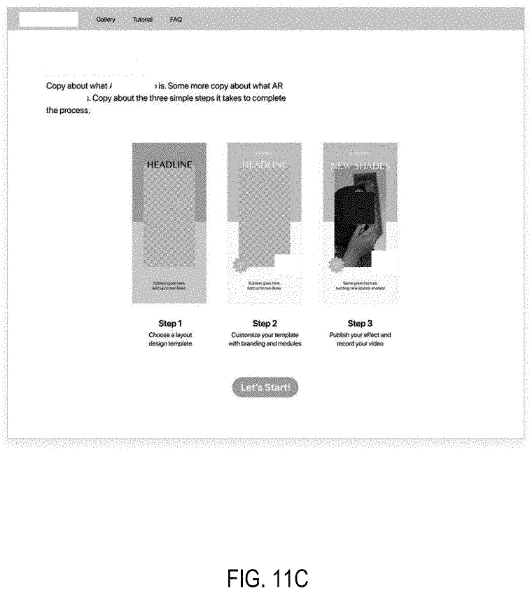

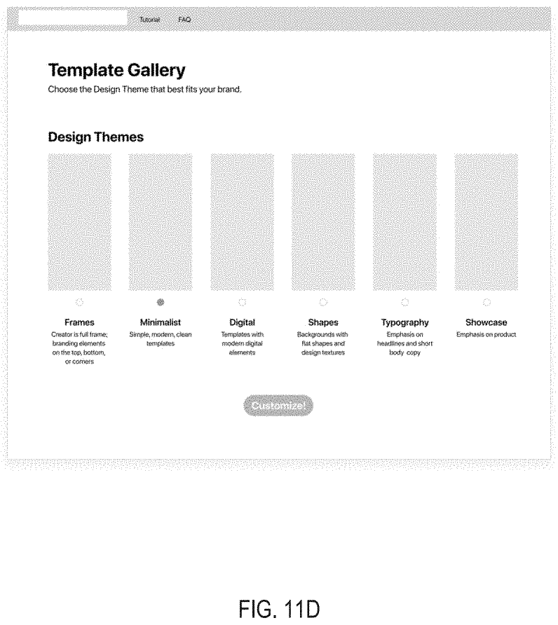

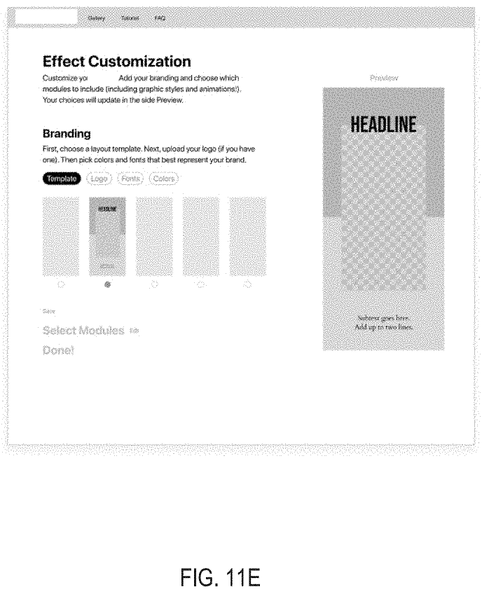

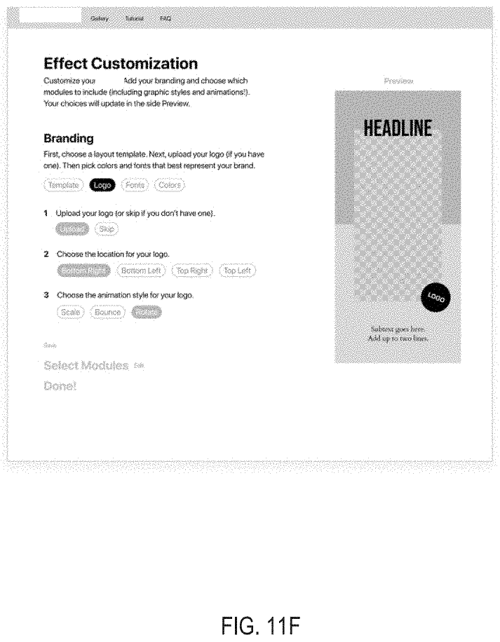

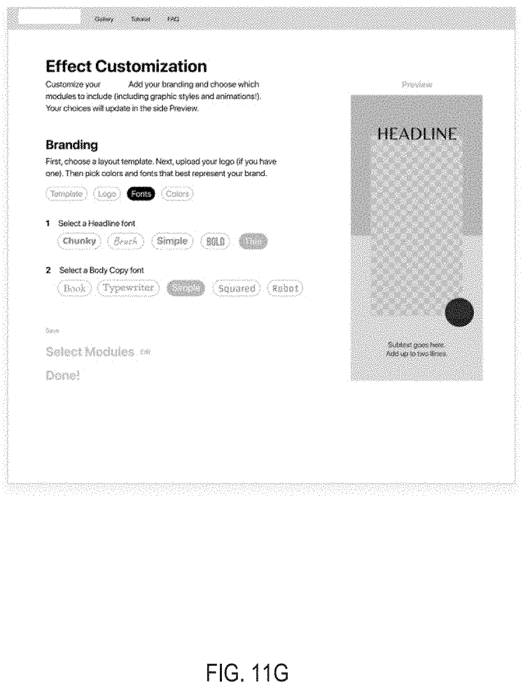

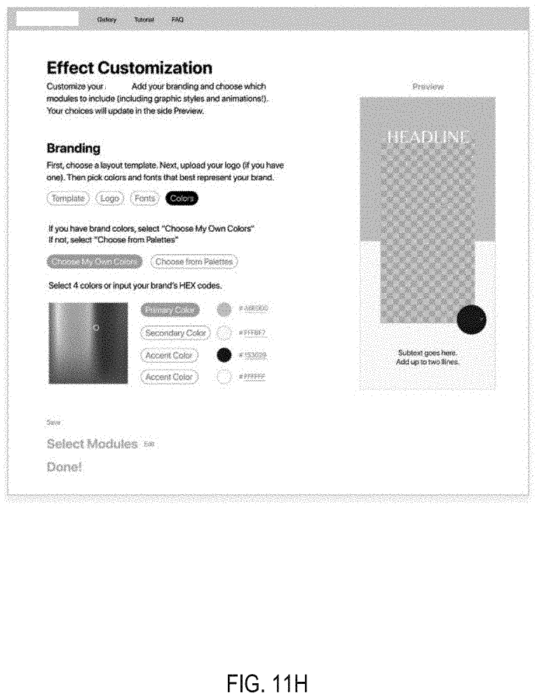

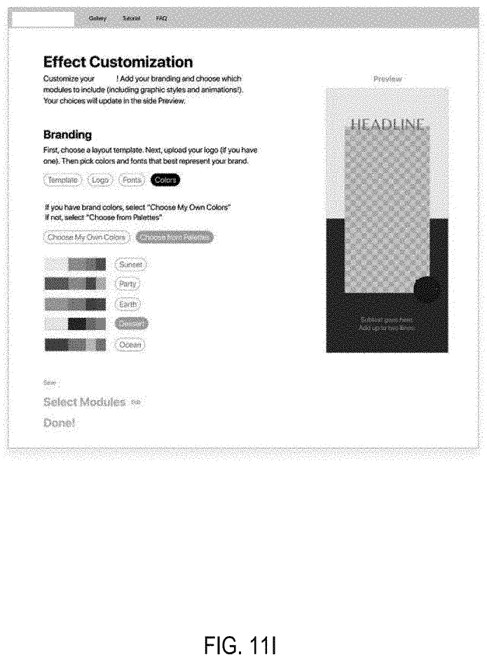

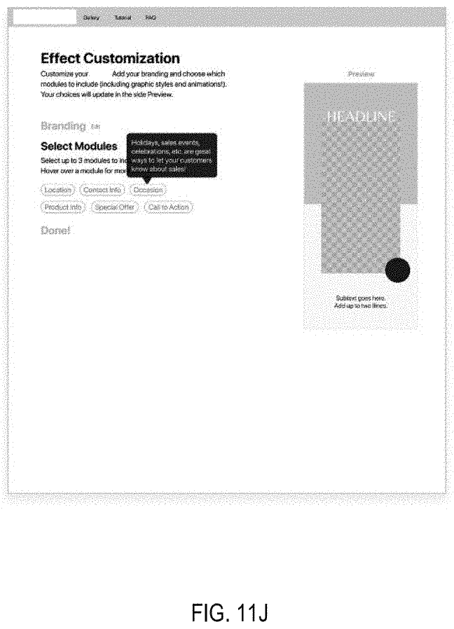

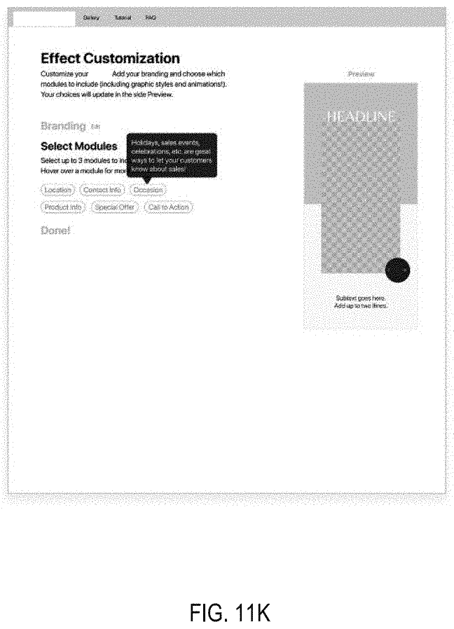

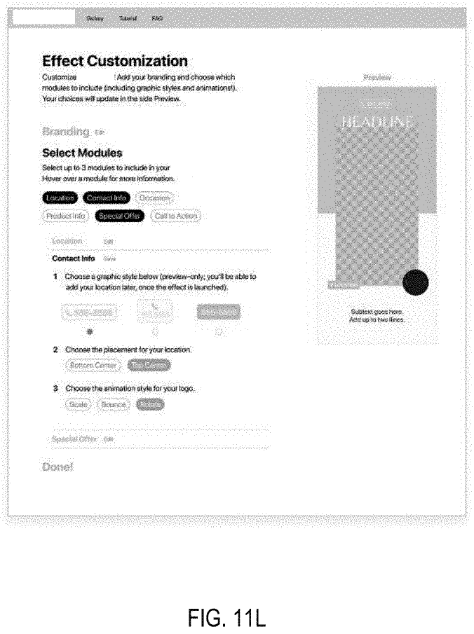

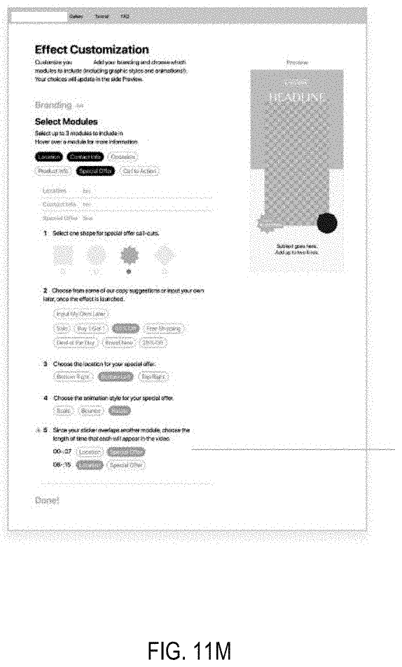

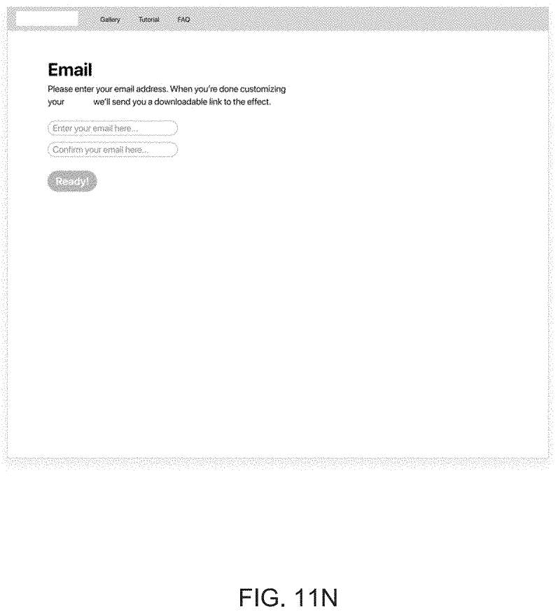

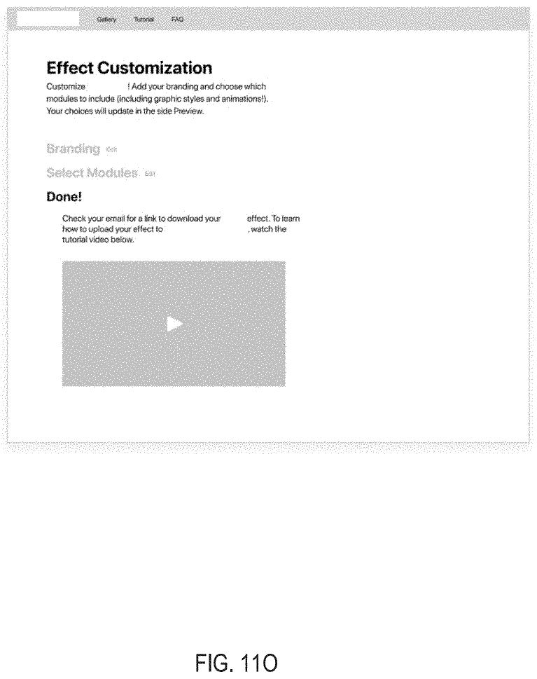

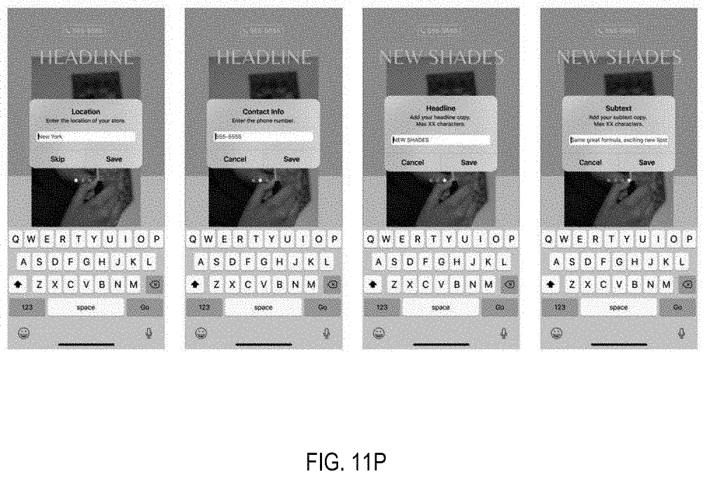

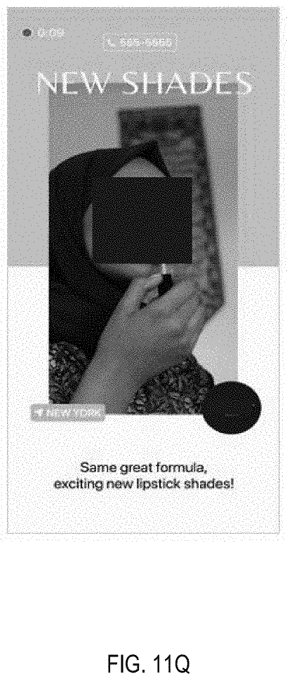

Reference is now made to FIGS. 11A-11B. FIG. 11A illustrates a block diagram of a system environment, including a system, that may be implemented to provide real-time generation of content according to a specified template using a real-time rendering ecosystem employing augmented reality (AR) techniques which may enable users to plurally and uniformly generate content, according to an example. FIG. 11B illustrates a block diagram of the system that may be implemented to provide real-time generation of content according to a specified template using a real-time rendering ecosystem employing augmented reality (AR) techniques which may enable users to plurally and uniformly generate content, according to an example.

As will be described in the examples below, one or more of system 1110, external system 1120, user devices 1130A-1130B and system environment 1100 shown in FIGS. 11A-11B may be operated by a service provider to provide real-time generation of content according to a specified template using a real-time rendering ecosystem employing augmented reality (AR) techniques which may enable users to plurally and uniformly generate content. It should be appreciated that one or more of the system 1110, the external system 1120, the user devices 1130A-1130B and the system environment 1100 depicted in FIGS. 11A-11B may be provided as examples. Thus, one or more of the system 1110, the external system 1120 the user devices 1130A-1130B and the system environment 1100 may or may not include additional features and some of the features described herein may be removed and/or modified without departing from the scopes of the system 1110, the external system 1120, the user devices 1130A-1130B and the system environment 1100 outlined herein. Moreover, in some examples, the system 1110, the external system 1120, and/or the user devices 1130A-1130B may be or associated with a social networking system, a content sharing network, an advertisement system, an online system, and/or any other system that facilitates any variety of digital content in personal, social, commercial, financial, and/or enterprise environments.

It should be appreciated that the systems and subsystems, as described herein, may include one or more servers or computing devices. Each of these servers or computing devices may further include a platform and at least one application. An application may include software (e.g., machine-readable instructions) stored on a non-transitory computer-readable medium and executable by a processor. A platform may be an environment on which an application is designed to run. For example, a platform may include hardware to execute the application, an operating system (OS), and runtime libraries. The application may be compiled to run on the platform. The runtime libraries may include low-level routines or subroutines called by the application to invoke some behaviors, such as exception handling, memory management, etc., of the platform at runtime. A subsystem may be similar to a platform and may include software and hardware to run various software or applications.

While the servers, systems, subsystems, and/or other computing devices shown in FIGS. 11A-11B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 1110, the external system 1120, the user devices 1130A-1130B or the system environment 1100.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of potentially personal, private, or sensitive data or information. These and other benefits will be apparent in the descriptions provided herein.

In some examples, the external system 1120 may include any number of servers, hosts, systems, and/or databases that store data to be accessed by the system 1110, the user devices 1130A-1130B, and/or other network elements (not shown) in the system environment 1100. In addition, in some examples, the servers, hosts, systems, and/or databases of the external system 1120 may include one or more storage mediums storing any data. In some examples, and as will be discussed further below, the external system 1120 may be utilized to store any information that may relate to generation and delivery of content (e.g., user information, etc.). As will be discussed further below, in other examples, the external system 1120 may be utilized by a service provider (e.g., a social media application provider) as part of an electronic distribution system, wherein a creating user may upload a universal resource locator (URL) link for distribution to creating users to enable the creating users to generate a content item according to a specified template.

In some examples, and as will be described in further detail below, the user devices 1130A-1130B may be utilized to, among other things, provide real-time generation and delivery of content according to a specified template using a rendering ecosystem. In some examples, the user devices 1130A-1130B may be electronic or computing devices configured to transmit and/or receive data. In this regard, each of the user devices 1130A-1130B may be any device having computer functionality, such as a television, a radio, a smartphone, a tablet, a laptop, a watch, a desktop, a server, or other computing or entertainment device or appliance. In some examples, the user devices 1130A-1130B may be mobile devices that are communicatively coupled to the network 1140 and enabled to interact with various network elements over the network 1140. In some examples, the user devices 1130A-1130B may execute an application allowing a user of the user devices 1130A-1130B to interact with various network elements on the network 1140. Additionally, the user devices 1130A-1130B may execute a browser or application to enable interaction between the user devices 1130A-1130B and the system 1110 via the network 1140. In some examples, and as will described further below, a client may utilize the user devices 1130A-1130B to access a browser and/or an application interface for providing real-time generation and delivery of content according to a specified template using a rendering ecosystem.

Moreover, in some examples and as will also be discussed further below, the user devices 1130A-1130B may be utilized by a user viewing content (e.g., advertisements) distributed by a service provider, wherein information relating to the user may be stored and transmitted by the user devices 1130A-1130B to other devices, such as the external system 1120. In particular, in one example, the user device 1130A may be a desktop computer that a creating user may use to specify aspects of a template to be created, whereas the user device 1130B may be a mobile phone that a publishing user may use to generate a content item (i.e., streaming video) utilizing and according the template specified by the creating user.

The system environment 1100 may also include the network 1140. In operation, one or more of the system 1110, the external system 1120 and the user devices 1130A-1130B may communicate with one or more of the other devices via the network 1140. The network 1140 may be a local area network (LAN), a wide area network (WAN), the Internet, a cellular network, a cable network, a satellite network, or other network that facilitates communication between, the system 1110, the external system 1120, the user devices 1130A-1130B and/or any other system, component, or device connected to the network 1140. The network 1140 may further include one, or any number, of the exemplary types of networks mentioned above operating as a stand-alone network or in cooperation with each other. For example, the network 1140 may utilize one or more protocols of one or more clients or servers to which they are communicatively coupled. The network 1140 may facilitate transmission of data according to a transmission protocol of any of the devices and/or systems in the network 1140. Although the network 1140 is depicted as a single network in the system environment 1100 of FIG. 11A, it should be appreciated that, in some examples, the network 1140 may include a plurality of interconnected networks as well.

It should be appreciated that in some examples, and as will be discussed further below, the system 1110 may be configured to utilize artificial intelligence (AI) based techniques and mechanisms to provide real-time generation and delivery of content according to a specified template using a rendering ecosystem. Details of the system 1110 and its operation within the system environment 1100 will be described in more detail below.

As shown in FIGS. 11A-11B, the system 1110 may include processor 1111 and the memory 1112. In some examples, the processor 1111 may be configured to execute the machine-readable instructions stored in the memory 1112. It should be appreciated that the processor 1111 may be a semiconductor-based microprocessor, a central processing unit (CPU), an application specific integrated circuit (ASIC), a field-programmable gate array (FPGA), and/or other suitable hardware device.

In some examples, the memory 1112 may have stored thereon machine-readable instructions (which may also be termed computer-readable instructions) that the processor 1111 may execute. The memory 1112 may be an electronic, magnetic, optical, or other physical storage device that contains or stores executable instructions. The memory 1112 may be, for example, random access memory (RAM), an Electrically Erasable Programmable Read-Only Memory (EEPROM), a storage device, an optical disc, or the like. The memory 1112, which may also be referred to as a computer-readable storage medium, may be a non-transitory machine-readable storage medium, where the term “non-transitory” does not encompass transitory propagating signals. It should be appreciated that the memory 1112 depicted in FIGS. 11A-11B may be provided as an example. Thus, the memory 1112 may or may not include additional features, and some of the features described herein may be removed and/or modified without departing from the scope of the memory 1112 outlined herein.

It should be appreciated that, and as described further below, the processing performed via the instructions on the memory 1112 may or may not be performed, in part or in total, with the aid of other information and data, such as information and data provided by the external system 1120 and/or the user devices 1130A-1130B. Moreover, and as described further below, it should be appreciated that the processing performed via the instructions on the memory 1112 may or may not be performed, in part or in total, with the aid of or in addition to processing provided by other devices, including for example, the external system 1120 and/or the user devices 1130A-1130B.

In some examples, the memory 1112 may store instructions, which when executed by the processor 1111, may cause the processor to: provide 103 a portal to enable a creating user to generate a template for a content item to be created; receive 104 information relating to a design specification for a template to be created; enable 105 a creating user to access a completed template; enable 106 a creating user to distribute a completed template to one or more publishing users; enable 107 a publishing user to publish a content item using a completed template.

In some examples, and as discussed further below, the instructions 1113-1117 on the memory 1112 may be executed alone or in combination by the processor 1111 to provide real-time generation and delivery of content according to a specified template using a rendering ecosystem. In some examples, the instructions 1113-1117 may be implemented in association with a content platform configured to provide content for users, while in other examples, the instructions 1113-1117 may be implemented as part of a stand-alone application.

Additionally, although not depicted, it should be appreciated that to provide real-time generation and delivery of content according to a specified template using a rendering ecosystem, instructions 1113-1117 may be configured to utilize various artificial intelligence (AI) based machine learning (ML) tools. For instance, these AI-based machine learning (ML) tools may be used to generate models that may include a neural network, a generative adversarial network (GAN), a tree-based model, a Bayesian network, a support vector, clustering, a kernel method, a spline, a knowledge graph, or an ensemble of one or more of these and other techniques. It should also be appreciated that the system 1110 may provide other types of machine learning (ML) approaches, such as reinforcement learning, feature learning, anomaly detection, etc.

In some examples, the instructions 1113 may provide a portal to enable a creating user to generate a template. In some examples, the portal may be an internet website that may be accessed via a browser interface by a creating user (e.g., an electronic commerce company). In some examples, the instructions 1113 may provide a step-by-step initiation to a creating user that may provide an overview of a process for generating a template. For example, in one instance, the website interface may indicate a three-step process, wherein a creating user may choose a layout design template, customize a template with branding and modules, and publish the template and/or generate a content item (e.g., record a video). FIG. 11C illustrates a user interface providing access to a portal for a creating user to specify aspects of a template.

In some examples, the instructions 1114 may receive information relating to a design specification for a template to be created. So, in some examples, the instructions 1114 may enable a creating user to select a design theme for the template. Examples of the design themes may include framed (i.e., wherein a user is shown in full frame, frame(s) show minimally on top, bottom, or on corners of displayed screen), minimalist (i.e., simple and clean and modern), showcase (i.e., emphasis on product images or content generating user), digital (i.e., modern digital elements), typography (i.e., emphasis on large headlines and short body copy) and shapes (i.e., backgrounds filled with flat shapes and design textures). It may be appreciated that providing a limited number of choices for design themes may contribute to uniformity of generated content items. FIG. 11D illustrates a user interface for selection of a design theme for a template.

In some examples, the instructions 1114 may enable a creating user to select a template type. In some examples, the instructions 1114 may provide a plurality of selectable template types, and may provide a (e.g., visual) preview for each as well. It should be appreciated that the template type may include any type of effect (e.g., an augmented reality (AR) effect) that may be supported by an augmented reality (AR) based rendering ecosystem. Furthermore, it should also be appreciated that the instructions 1114 may implement any effect (e.g., augmented reality (AR) effect) in a selected template, and may provide a user an opportunity to modify the effect as well. FIG. 11E illustrates a user interface for selection of a template type.

In some examples, the instructions 1114 may enable a creating user to upload a logo. Furthermore, in some examples, the instructions 1114 may enable a creating user to choose a location for the logo to appear on a template, and may also choose an presentation style for the logo as well. In some examples, the instructions 1114 may enable a (e.g., visual) preview of the logo as well. FIG. 11F illustrates a user interface for selection of a logo.

In some examples, the instructions 1114 may enable a creating user to select a font. In some examples, the instructions 1114 may enable a creating user to choose a font for a title/headline, and may also enable the creating user to choose a body font. In some examples, the instructions 1114 may enable a (e.g., visual) preview of a selected font as well. FIG. 11G illustrates a user interface for selection of a font for a template.

In some examples, the instructions 1114 may enable a creating user to select colors associated with template. Indeed, in some examples, the instructions 1114 may enable a creating user to choose a primary color, a secondary color and one or more accent colors. FIG. 11H illustrates a first user interface for selection of one or more colors for a template. In other examples, the instructions 1114 may enable a creating user to choose a color palette (i.e., a selection of colors). FIG. 11I illustrates a second user interface for selection of one or more colors for a template. Also, in some examples, the instructions 1114 may enable a (e.g., visual) preview of the selected colors and/or color palettes.

In some examples, the instructions 1114 may enable a creating user to input miscellaneous aspects associated with a template. In some instances, these may be referred to as “modules”. Examples of the miscellaneous aspects that may be specified may include location (i.e., placement), contact information, occasion (i.e., event), associated product or service information, special offers and call(s) to action. Also, examples of the types of occasions may include Valentine's Day, Mother's Day, Christmas and New Year's Day. In some examples, the instructions 1114 may provide a (e.g., visual) preview of a miscellaneous aspect as well. FIG. 11J illustrates a user interface for selection of one or more modules for a template.

In some examples, upon selection of one or more miscellaneous aspects to be specified, the instructions 1114 may further enable a creating user to input related information. Examples of the related information are discussed further below. It should be appreciated that if one selected aspect may conflict (i.e., overlap) with another, the instructions 1114 may enable a creating user to specify a length of time that each may appear on the template.

In some examples, to specify a location, the instructions 1114 may enable a creating user to input information relating to a graphic style, a particular placement and/or an animation style. FIG. 11K illustrates a user interface for selection of a location for a template.

In some examples, to specify contact information, the instructions 1114 may enable a creating user to specify a graphic style, a placement and an animation style. FIG. 11L illustrates a user interface for providing contact information.

In some examples, to specify a special offer, the instructions 1114 may enable a creating user to specify a shape, location and an animation style. Also, in some examples, the instructions 1114 may further suggest associated copy (i.e., descriptive text) as well. FIG. 11M illustrates a user interface for providing information related to a special offer.

In some examples, the instructions 1114 may enable a creating user to specify contact information (e.g., an email address) where a completed template may be sent. In some examples, the instructions 1114 may send an email to a creating user that may include a uniform resource locator (URL) link that may enable the creating user to access the completed template. FIG. 11N illustrates a user interface for enabling a creating user to input a delivery email address.

In some examples, the instructions 1114 may indicate that a completed template is ready to be sent, and may provide a (e.g., visual) preview of a completed template as well. FIG. 11O illustrates a user interface for a completion page for a completed template.

In some examples, the instructions 1115 may enable a creating user to access a completed template. In some examples, the instructions 1115 may send an email to the creating user that may include a uniform resource locator (URL) link to access the completed template. In some examples, upon the creating user selecting (i.e., clicking) the uniform resource locator (URL) link, the instructions 1115 may enable the creating user to download the completed template. In some examples, the creating user may utilize the completed template to create a content item having a supplemental effect.

In some examples, the instructions 1116 may enable a creating user to distribute a completed template to one or more publishing users. So, in one example, a vendor may upload a completed template for distribution to one or more sales associates, who may then use the completed template to create content with a specified supplemental effect. It should be appreciated that, during the process of distributing the completed template, the instructions 1116 may enable a creating user to edit aspects of the template (e.g., an effect) prior to completion.

In some examples, the instructions 1116 may enable a creating user to access and utilize a distribution system that may send the completed template to the publishing users. So, in some examples, the instructions 1116 may enable a creating user to access contact information for the publishing users, and may enable the creating user to transmit an electronic communication providing access to the completed template to the publishing users. In some examples, the contact information of the publishing users may be stored on the external system 1120. In other examples, the instructions 1116 may enable the creating user to publish the completed template to a social media platform, and in still other examples, the instructions 1116 may enable the creating user to transmit to a user device (e.g., a mobile device) as well.

In some examples, the instructions 1116 may provide access to a completed template via a usage item. In some examples, the usage item may be a uniform resource locator (URL) link. In these examples, upon receipt of the uniform resource locator (URL) link, a publishing user may select the uniform resource locator (URL) link to gain access to the template for use.

Also, in some examples, the instructions 1116 may provide a uniform resource locator (URL) link that may open directly into a content platform (e.g., a social media platform). That is, in some examples, upon selection by a publishing user, the uniform resource locator (URL) link may open directly into a content platform and may enable content generation (e.g., real-time streaming video) according to the completed template.

In some examples, the instructions 1117 may enable a publishing user to publish a content item using a completed template. As discussed above, in some examples, the publishing user may begin generating a content item by engaging (e.g., selecting) a usage item (e.g., a uniform resource locator (URL) link). In these examples, the instructions 1117 may enable a publishing user to record and/or publish a content item using the template.

In some examples, upon receipt of a template by a publishing user, the instructions 1117 may enable a publishing user to provide various publication information. Examples of publication information that may be provided include a publishing user's location, a publishing user's contact info (e.g., phone number), a headline or title, and/or associated copy to be utilized during generation of a content item. In some instances, the publication information provided by the publishing user may be utilized during generation of a content item. FIG. 11P illustrates a plurality of user interfaces for receiving publication information from a publishing user.

So, in some examples, the instructions 1117 may enable a publishing user to record a video, wherein the supplemental effects provided by the (specified) template may be added to the recorded video. In other examples, the publishing user may generate a content item by live streaming a video in real-time, wherein the supplemental effects provided by the (specified) template may be added to/during the live stream. In these examples, the supplemental effects may appear to viewers (e.g., of the live stream) in combination with the streamed video. FIG. 11Q illustrates a user interface of a generated content item generated.

In some examples, the instructions 1117 may utilize a rendering ecosystem implementing augmented reality (AR) techniques to process incoming content data. In some examples, the instructions 1117, in combination with the rendering ecosystem, may add a supplemental effect specified by a template to enable publishing users to plurally and uniformly generate content according to a creating user's specifications.

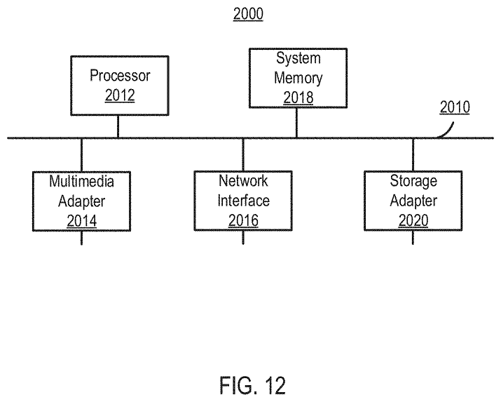

FIG. 12 illustrates a block diagram of a computer system for customized outreach plan generation and optimization based on virtual structures, according to an example. In some examples, the system 2000 may be associated the system 100 to perform the functions and features described herein. The system 2000 may include, among other things, an interconnect 2010, a processor 2012, a multimedia adapter 2014, a network interface 2016, a system memory 2018, and a storage adapter 2020.

The interconnect 2010 may interconnect various subsystems, elements, and/or components of the external system 200. As shown, the interconnect 2010 may be an abstraction that may represent any one or more separate physical buses, point-to-point connections, or both, connected by appropriate bridges, adapters, or controllers. In some examples, the interconnect 2010 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 2010 may allow data communication between the processor 2012 and system memory 2018, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 2012 may be the central processing unit (CPU) of the computing device and may control overall operation of the computing device. In some examples, the processor 2012 may accomplish this by executing software or firmware stored in system memory 2018 or other data via the storage adapter 2020. The processor 2012 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 2014 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 2016 may provide the computing device with an ability to communicate with a variety of remote devices over a network (e.g., network 1140 of FIG. 11A) and may include, for example, an Ethernet adapter, a Fibre Channel adapter, and/or other wired- or wireless-enabled adapter. The network interface 2016 may provide a direct or indirect connection from one network element to another, and facilitate communication and between various network elements.

The storage adapter 2020 may connect to a standard computer-readable medium for storage and/or retrieval of information, such as a fixed disk drive (internal or external).

Many other devices, components, elements, or subsystems (not shown) may be connected in a similar manner to the interconnect 2010 or via a network (e.g., network 1140 of FIG. 11A). Conversely, all of the devices shown in FIG. 12 need not be present to practice the present disclosure. The devices and subsystems can be interconnected in different ways from that shown in FIG. 12. Code to implement the dynamic approaches for payment gateway selection and payment transaction processing of the present disclosure may be stored in computer-readable storage media such as one or more of system memory 2018 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, 10S, ANDROID, UNIX, Linux, or another operating system.

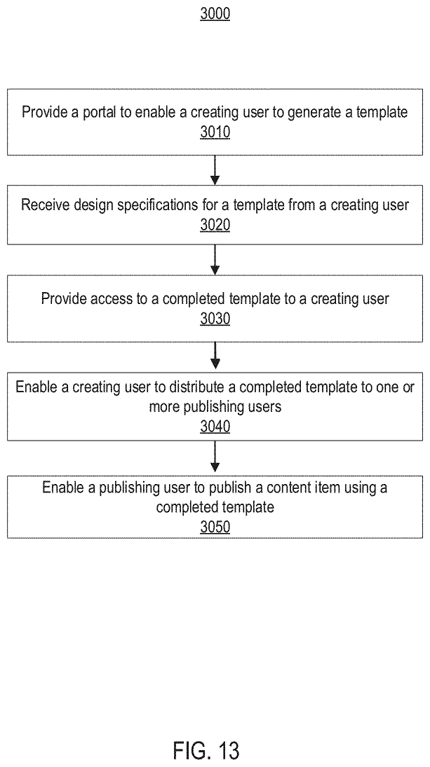

FIG. 13 illustrates a method 3000 for providing real-time generation and delivery of content according to a specified template using a rendering ecosystem, according to an example. The method 3000 is provided by way of example, as there may be a variety of ways to carry out the method described herein. Each block shown in FIG. 13 may further represent one or more processes, methods, or subroutines, and one or more of the blocks may include machine-readable instructions stored on a non-transitory computer-readable medium and executed by a processor or other type of processing circuit to perform one or more operations described herein.

Although the method 3000 is primarily described as being performed by system 100 as shown in FIGS. 11A-11B, the method 3000 may be executed or otherwise performed by other systems, or a combination of systems. It should be appreciated that, in some examples, to provide real-time generation and delivery of content according to a specified template using a rendering ecosystem, the method 3000 may be configured to incorporate artificial intelligence (AI) or deep learning techniques, as described above. It should also be appreciated that, in some examples, the method 3000 may be implemented in conjunction with a content platform (e.g., a social media platform) to generate and deliver content.

Reference is now made with respect to FIG. 13. At 3010, the processor 1111 may provide a portal to enable a creating user to generate a template. In some examples, in generating the template, the processor 1111 may provide an internet website that may be accessed via a browser interface.

At 3020, the processor 1111 may receive design specifications for a template from a creating user. In some examples, the design specifications may include a design theme, a template type, one or more fonts, and one or more colors to be associated with the template. Also, in some examples, the design specifications may include location, contact information, (special) occasions or call(s) to action. It should be appreciated that the processor 1111 may enable a (e.g., visual) preview for each of the provided design specifications as well.

At 3030, the processor 1111 may provide access to a completed template to a creating user. In some examples, the processor 1111 may transmit an email communication that may include a uniform resource locator (URL) link that may be selected to initiate a download of the completed template.

At 3040, the processor 1111 may enable a creating user to distribute a completed template to one or more publishing users. In some examples, the processor 1111 may enable a creating user to access a distribution system that may enable the creating user to transmit an electronic communication (e.g., an email, a text message) that may provide access to the completed template. In some examples, the electronic communication may include a usage item (e.g., a uniform resource locator (URL)) that may open directly into a content platform and may enable real-time content generation (e.g., streaming video) using the completed template.

At 3050, the processor 1111 may enable a publishing user to publish a content item using a completed template. That is, in some examples, upon selection of a usage item by the publishing user, the processor 1111 may enable a publishing user to record a video wherein the supplemental effects provided by the completed template may be added. In these examples, the supplemental effects may be added to the content item and may be viewed in concert with content published by the publishing user.

With regard to the Figures described above, and with particular regard to FIG. 1A, it should be noted that the functionality described herein may be subject to one or more privacy policies, described below, enforced by the local systems, the user communication devices 192, 194, . . . , etc., and the storage device 170, may bar the use of information obtained from one or more of the plurality of data feeds.

In particular examples, one or more objects of a computing system may be associated with one or more privacy settings. The one or more objects may be stored on or otherwise associated with any suitable computing system or application, such as, for example, the computer system 100, the user communication devices 192, 194, . . . , etc., and the storage device 170, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the computer system 100, the user communication devices 192, 194, . . . , etc., and the storage device 170 or shared with other systems. Although this disclosure describes using particular privacy settings in a particular manner, this disclosure contemplates using any suitable privacy settings in any suitable manner.

In particular examples, the computer system 100, the user communication devices 192, 194, . . . , etc., and the storage device 170 may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the computer system 100, the user communication devices 192, 194, . . . , etc., and the storage device 170 may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics. As an example and not by way of limitation, a first user may specify that other users who attend the same university as the first user may view the first user's pictures, but that other users who are family members of the first user may not view those same pictures.

In particular examples, the computer system 100, the user communication devices 192, 194, . . . , etc., and the storage device 170 may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the computer system 100, the user communication devices 192, 194, . . . , etc., and the storage device 170 may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The computer system 100, the user communication devices 192, 194, . . . , etc., and the storage device 170 may access such information in order to provide a particular function or service to the first user, without the computer system 100, the user communication devices 192, 194, . . . , etc., and the storage device 170 having access to that information for any other purposes. Before accessing, storing, or using such objects or information, the computer system 100, the user communication devices 192, 194, . . . , etc., and the storage device 170 may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the computer system 100, the user communication devices 192, 194, . . . , etc., and the storage device 170.

In particular examples, a user may specify whether particular types of objects or information associated with the first user may be accessed, stored, or used by the computer system 100, the user communication devices 192, 194, . . . , etc., and the storage device 170. As an example and not by way of limitation, the first user may specify that images sent by the first user through the computer system 100, the user communication devices 192, 194, . . . , etc., and the storage device 170 may not be stored by the computer system 100, the user communication devices 192, 194, . . . , etc., and the storage device 170. As another example and not by way of limitation, a first user may specify that messages sent from the first user to a particular second user may not be stored by the computer system 100, the user communication devices 192, 194, . . . , etc., and the storage device 170. As yet another example and not by way of limitation, a first user may specify that all objects sent via a particular application may be saved by the computer system 100, the user communication devices 192, 194, . . . , etc., and the storage device 170.

In particular examples, privacy settings may allow a first user to specify whether particular objects or information associated with the first user may be accessed from the computer system 100, the user communication devices 192, 194, . . . , etc., and the storage device 170. The privacy settings may allow the first user to opt in or opt out of having objects or information accessed from a particular device (e.g., the phone book on a user's smart phone), from a particular application (e.g., a messaging app), or from a particular system (e.g., an email server). The computer system 100, the user communication devices 192, 194, . . . , etc., and the storage device 170 may provide default privacy settings with respect to each device, system, or application, and/or the first user may be prompted to specify a particular privacy setting for each context. As an example and not by way of limitation, the first user may utilize a location-services feature of the computer system 100, the user communication devices 192, 194, . . . , etc., and the storage device 170 to provide recommendations for restaurants or other places in proximity to the user. The first user's default privacy settings may specify that the computer system 100, the user communication devices 192, 194, . . . , etc., and the storage device 170 may use location information provided from one of the user communication devices 192, 194, . . . etc., of the first user to provide the location-based services, but that the computer system 100, the user communication devices 192, 194, . . . , etc., and the storage device 170, may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The computer system 100, the user communication devices 192, 194, . . . , etc., and the storage device 170 may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the computer system 100, the user communication devices 192, 194, . . . , etc., and the storage device 170 may use a user's previous activities and calculated moods, emotions, or sentiments to determine a present mood, emotion, or sentiment. A user who wishes to enable this functionality may indicate in their privacy settings that they opt in to the computer system 100, the user communication devices 192, 194, . . . , etc., and the storage device 170 receiving the inputs necessary to determine the mood, emotion, or sentiment. As an example and not by way of limitation, the computer system 100, the user communication devices 192, 194, . . . , etc., and the storage device 170 may determine that a default privacy setting is to not receive any information necessary for determining mood, emotion, or sentiment until there is an express indication from a user that the computer system 100, the user communication devices 192, 194, . . . , etc., and the storage device 170 may do so. By contrast, if a user does not opt in to the computer system 100, the user communication devices 192, 194, . . . , etc., and the storage device 170 receiving these inputs (or affirmatively opts out of the computer system 100, the user communication devices 192, 194, . . . , etc., and the storage device 170 receiving these inputs), the computer system 100, the user communication devices 192, 194, . . . , etc., and the storage device 170 may be prevented from receiving, collecting, logging, or storing these inputs or any information associated with these inputs. In particular examples, the computer system 100, the user communication devices 192, 194, . . . , etc., and the storage device 170 may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the computer system 100, the user communication devices 192, 194, . . . , etc., and the storage device 170 may use the user's mood, emotion, or sentiment to provide newsfeed items, pages, friends, or advertisements to a user. The user may specify in their privacy settings that the computer system 100, the user communication devices 192, 194, . . . , etc., and the storage device 170 may determine the user's mood, emotion, or sentiment. The user may then be asked to provide additional privacy settings to indicate the purposes for which the user's mood, emotion, or sentiment may be used. The user may indicate that the computer system 100, the user communication devices 192, 194, . . . , etc., and the storage device 170 may use his or her mood, emotion, or sentiment to provide newsfeed content and recommend pages, but not for recommending friends or advertisements. The computer system 100, the user communication devices 192, 194, . . . , etc., and the storage device 170 may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the computer system 100, the user communication devices 192, 194, . . . , etc., and the storage device 170 may be restricted in its access, storage, or use of the objects or information. The computer system 100, the user communication devices 192, 194, . . . , etc., and the storage device 170 may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the computer system 100, the user communication devices 192, 194, . . . , etc., and the storage device 170 may temporarily store the message in a content data store until the second user has viewed or downloaded the message, at which point the computer system 100, the user communication devices 192, 194, . . . , etc., and the storage device 170 may delete the message from the data store. As another example and not by way of limitation, continuing with the prior example, the message may be stored fora specified period of time (e.g., 2 weeks), after which point may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the computer system 100, the user communication devices 192, 194, . . . , etc., and the storage device 170 may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the computer system 100, the user communication devices 192, 194, . . . , etc., and the storage device 170. The user's privacy settings may specify that such information may be used only for particular processes, such as authentication, and further specify that such information may not be shared with any external system or used for other processes or applications associated with the computer system 100, the user communication devices 192, 194, . . . , etc., and the storage device 170. As another example and not by way of limitation, the computer system 100, the user communication devices 192, 194, . . . , etc., and the storage device 170 may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the computer system 100, the user communication devices 192, 194, . . . , etc., and the storage device 170. As another example and not by way of limitation, the computer system 100, the user communication devices 192, 194, . . . , etc., and the storage device 170 may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the computer system 100, the user communication devices 192, 194, . . . , etc., and the storage device 170.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The computer system 100, the user communication devices 192, 194, . . . , etc., and the storage device 170 may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the computer system 100, the user communication devices 192, 194, . . . , etc., and the storage device 170 may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the computer system 100, the user communication devices 192, 194, . . . , etc., and the storage device 170 may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the computer system 100, the user communication devices 192, 194, . . . , etc., and the storage device 170 may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the computer system 100, the user communication devices 192, 194, . . . , etc., and the storage device 170 may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the computer system 100, the user communication devices 192, 194, . . . , etc., and the storage device 170 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the computer system 100, the user communication devices 192, 194, . . . , etc., and the storage device 170 may send a reminder to the user to confirm his or her privacy settings every six months or after every ten photo posts. In particular examples, privacy settings may also allow users to control access to the objects or information on a per-request basis. As an example and not by way of limitation, the computer system 100, the user communication devices 192, 194, . . . , etc., and the storage device 170 may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system for providing content, comprising:
a processor; and
a memory storing instructions, which is executable by the processor.

2. The system of claim 1, wherein the instructions, when executed by the processor, cause the processor to:
receive a plurality of data feeds corresponding to a plurality of data sources;
to determine values for one or more parameterized variables from the plurality of data feeds;
identify at least one rule associated with the one or more parameterized variables, wherein the at least one rule enables providing dynamic digital content to users; and
generate the dynamic digital content in accordance with the at least one rule.

3. The system of claim 2, wherein the instructions, when executed by the processor, cause the processor to:
transmit the dynamic digital content to one or more user communication devices of a selected audience.

4. The system of claim 2, wherein the instructions, when executed by the processor, cause the processor to:
select the users to receive the dynamic digital content based on the at least one rule, wherein the at least one rule includes at least two rules.

5. The system of claim 2, wherein the instructions, when executed by the processor, cause the processor to:
extract attribute data of trending products by employing a plurality of deep learning models that are trained to extract the attribute data of the trending products.

6. The system of claim 5, wherein the instructions, when executed by the processor, cause the processor to:
match the attribute data of trending products with user preference data; and
provide a user with a dynamic trending product catalog based on the matches between the attribute data and the user preference data.

7. The system of claim 2, wherein the one or more parameterized variables include one or more of a notification reach, a notification transmission frequency, a target user, a target segment, or a content of a notification.

8. The system of claim 2, wherein generating the dynamic digital content includes generating the dynamic digital content from predetermined templates based on the one or more parameterized variables.

9. The system of claim 2, wherein the instructions, when executed by the processor, cause the processor to:
receive a request for presenting a digital content item at a user device of a user;
determine that the user is an opt-out user;
provide the digital content item enabled for collecting feedback data from the opt-out user at the user device;
record the feedback data in an exclusion list of a user profile associated with the opt-out user, wherein the feedback data indicates one or more excluded digital content items to be excluded from display to the user; and
provide filtered digital content items for display to the opt-out user based on the exclusion list, wherein the filtered digital content items are not included in the exclusion list.

10. The system of claim 9, wherein the instructions when executed by the processor further cause the processor to select the filtered digital content items for display to the user wherein the filtered digital content items are dissimilar to the digital content items included in the exclusion list.

11. The system of claim 9, wherein the instructions, when executed by the processor, cause the processor to select the filtered digital content items for display to the user wherein the filtered digital content items are from content sources not included in the exclusion list.

12. The system of claim 9, wherein the instructions, when executed by the processor, further cause the processor to enable providing incentives to the opt-out user for providing the feedback.

13. The system of claim 9, wherein the request for presenting a digital content item includes identifying an opportunity to present the digital content item to the user device.

14. The system of claim 9, wherein the feedback data from the opt-out user includes feedback regarding whether the digital content item is to be added to an exclusions list in a user profile associated with the opt-out user.

15. A method for providing real-time generation and delivery of content according to a specified template using a rendering ecosystem.

16. The method of claim 15, wherein the method comprises:
enabling a creating user to generate a template for content items;
receiving information relating to a design specification for the template;
enabling the creating user to access a completed template;
enabling the creating user to distribute the completed template to one or more publishing users; and
enabling a publishing user of the one or more publishing users to publish a content item to be published using the completed template.

17. A non-transitory computer-readable storage medium having an executable stored thereon, which when executed instructs a processor to perform the method of claim 16.

18. The method of claim 16, rendering the content item to be published via a rendering ecosystem utilizing augmented reality (AR) techniques.

19. A non-transitory computer-readable storage medium having an executable stored thereon, which when executed instructs a processor to perform the method of claim 17.

20. The method of claim 16, further comprising enabling the creating user to access a completed template includes transmitting a communication including a uniform resource locator (URL) link for initiating a download of the completed template.
